(19) United States
(12) Patent Application Publication
(10) Pub. No.: US 2020/0402363 A1
(43) Pub. Date: Dec. 24, 2020

(54) ENHANCED GAMES OF CHANCE AND METHODS FOR PLAYING SUCH GAMES

(71) Applicant: Craig J. Madson, Morgan, UT (US)

(72) Inventor: Craig J. Madson, Morgan, UT (US)

(21) Appl. No.: 16/993,081

(22) Filed: Aug. 13, 2020

Related U.S. Application Data
(63) Continuation-in-part of application No. 16/281,041, filed on Feb. 20, 2019.
Application No. 16/281,041 is a continuation-in-part of application No. 14/194,250, filed on Feb. 28, 2014, now abandoned.
(60) Provisional application No. 61/781,224, filed on Mar. 14, 2013.

(51) Int. Cl. G07F 17/32

(52) U.S. Cl. CPC G07F 17/3262; G07F 17/3295; G07F 17/3272; G07F 17/3216

(57) ABSTRACT

A game of chance for wagering players uses a plurality of random number selectors added together to determine a point sum and has a game layout. The game layout has a plurality of point-sum zones, each indicating at least one point-sum indicia and a plurality of wagering zones. The wagering zones has primary wager zones, each being associated with one of the point-sum zones; secondary wager zones, each being associated with more than one of the point-sum zones; and at least one tertiary wager zone being associated with more than one of the secondary wager zones and the point-sum zones associated with each of the secondary wager zones. Each of the wagering zones has predetermined odds indicia. The wagering player is paid according to the odds indicia when the point sum matches the point-sum indicia associated with at least one of the wagering zones.

### RELATED APPLICATIONS

This application is a continuation-in-part application of U.S. patent application Ser. No. 16/281,041 filed on Feb. 20, 2019, titled “Games of Chance and Methods for Playing Such Games” (referred to herein as the “Parent CIP Application”). The Parent CIP Application is a continuation-in-part application of U.S. patent application Ser. No. 14/194,250 filed on Feb. 28, 2014, titled “Games of Chance and Methods for Playing Such Games” (referred to herein as the “Grandparent Application”). The Grandparent Application claims the benefit of U.S. Provisional Patent Application Ser. No. 61/781,224 that was filed on Mar. 14, 2013, for an invention titled “Games of Chance and Methods for Playing Such Games.” Each of the related applications mentioned in this paragraph is hereby incorporated by this reference as if fully set forth herein.

### BACKGROUND OF THE INVENTION

### 1. Field of the Invention

The present invention relates generally to games of chance and methods for playing such games of chance. More specifically, the present invention relates to various games of chance that implement associated wagering regions and the sum of multiple number selectors.

### 2. The Relevant Technology

Games incorporating elements of chance are well known. These games are known both in the context of casino games as well as parlor games. Games of chance generally revolve around the outcome or outcomes of some random or quasi-random event or events. These events have a limited set of possible outcomes, although the set of possible outcomes may be very large. Generally, game players attempt to predict the outcome of one or more events prior to their occurrence. Game winners may be determined by correctly predicting all or part of the outcome of the event or events.

Games of chance have particular application in the field of casino gaming. Casino gaming as used herein is understood to include gambling applications outside of actual casinos, for example, in locations such as bars, airports and the like which may have gambling. It is understood that casino gaming may include both table-based gaming, as well as machine-based gaming, including, for example, mechanical slot machine gaming, computer-controlled machine gaming, and gaming using a personal mobile device such as a laptop, a tablet, and a smart phone.

Well known casino games include craps, roulette, blackjack, pai gow poker, pai gow, the wheel of fortune, slot machines, video poker, keno, baccarat, mini-baccarat, Spanish-21, casino war, and poker. Also, games such as state lotteries and daily numbers drawings are well known.

The principal goal of games of chance is to provide entertainment. In the casino and gambling context, successful games attract and maintain the interest of players, thereby generating income for the casino or other game host. These games of chance ideally provide action and excitement for players, have relatively easy to learn rules which do not use complicated rankings of various outcomes (e.g., poker hand valuations), and permit a variety of different wagers to keep players' interest.

In order to create a sense of competition, and therefore excitement and interest, certain presently-known games of chance determine winners by comparing the outcome of a player's event (such as the roll of one or more dice) against the results of a similar event of a “dealer” or other player.

One example of such a game of chance applicable in the casino setting is disclosed in U.S. Pat. No. 5,413,351, which discloses a dice game involving wagering on the outcome of a roll of three dice. One or more players place wagers and then roll dice against a dealer. Game results depend on the occurrence of a predefined set of outcomes and/or the relative values of the player's and dealer's outcomes.

U.S. Pat. No. 5,513,850 discloses a game in which a player and a dealer develop “hands” based on the outcome of one or more rolls of several dice by both the dealer and player. Game results depend on the value of the dealer's hand relative to the player's hand according to a predefined set of relatively complex rules.

U.S. Pat. No. 6,062,563 discloses a game in which a player and a dealer each roll a set of dice. Wagers are made on the relative outcome of the two rolls. The player's dice and dealer's dice may be differentiated from one another by color so to avoid confusion upon each rolling his respective dice.

U.S. Pat. No. 5,695,193 discloses a game in which players play against one another or against a dealer. Game results are based on predefined combinations of dice outcomes. Outcome combinations are compared to that of each player in turn and the combination with the highest value according to predefined point values assigned to each possible outcome is deemed the winner.

U.S. Pat. No. 8,011,663 discloses a game of chance that defines a set of wagers on the outcome of a plurality of differentiable random events. The random events define an aggregate event to which a set of payout odds are associated. Up to five dice may be differentiated from one another by color so to differentiate the dice for different wagering combinations. After wagers are accepted, a plurality of random events is generated. Winning wagers are paid according to the payout odds.

Many players, however, seek to avoid confrontation and so disfavor games involving such inter-personal competition, even when such competition is against a casino as personified by a dealer.

Other presently-known games attempt to create excitement by providing multiple wagering stages during the course of a single game. U.S. Pat. No. 5,513,851, for example, discloses a dice-based game that requires players to place at least one additional wager on at least one additional roll of several dice after successfully wagering on the outcome of a first roll of the several dice.

Still other presently-known games attempt to attract players by providing a limited set of wagers which players may learn quickly. One such game is disclosed in U.S. Pat. No. 5,732,948, which discloses a dice-based game having a small set of available wagers. The outcome of the game is dependent on no more than two rolls of a pair of dice. The game may be terminated upon the occurrence of a predefined outcome during a first roll of dice, or upon the occurrence of certain outcomes of a second roll of dice relative to the outcome of the first roll the dice.

Similarly, U.S. Pat. No. 6,234,482 discloses a multiple dice game wherein players' wagers relate to the outcome of a roll of three dice without differentiation of three dice. Wagers are limited to wagers regarding the total of the three dice and/or the existence of two or three identical numbers being rolled.

U.S. Pat. No. 6,508,469 discloses a multiple-dice game wherein players wager on the sum of the outcome of two rolls of three dice each and/or on poker-like outcomes (e.g., three-of-a-kind, straights, etc.) without differentiation of the dice. Wagers may be made before the first roll and/or between the first and second rolls.

U.S. Pat. No. 6,209,874 discloses a three-dice game having dice of three different colors. Players are limited to six types of wagers on the result of rolling three dice. A first type of wager is on the face-up sides of a selected two of the dice being equal both to each other and to a number selected by the player. A second type of wager is on the face-up side of a selected one of the dice indicating a selected number. A third type of wager is on the face-up side of a selected one of the dice indicating a number that is alternatively higher or lower than numbers indicated by the other two dice. A fourth type of wager is on the face up sides of the dice each being equal to each other and to a number selected by the player. A fifth type of wager is on the face-up sides of the dice indicating numbers having a sum which is a selected total number. A sixth type of wager is on the sum of numbers indicated by the face-up sides of the three dice being alternatively an odd number or an even number.

Due to the limited scope of available wagers, however, these games may not adequately maintain the interest of players. Certain presently-known games address this issue by providing more complicated rules. One example is U.S. Pat. No. 5,350,175, which discloses a dice-based game wherein players wager on the outcomes of successive rolls of several dice. The game terminates upon the happening of certain pre-defined combinations of outcomes of the several rolls of the dice.

Similarly, U.S. Pat. No. 6,070,872 discloses a combination card and dice-based game which proceeds through three distinct phases of random card and dice events. These games, however, may present rules which are too complicated for a number of typical players to comfortably learn or understand.

Finally, several currently-known games involve game play which does not adequately develop excitement for players.

U.S. Pat. No. 5,806,847 discloses a game wherein players wager on the outcome of a single event such as the roll of a pair of dice. Several pre-defined wagers are disclosed, such as the outcome of the event being included in one or more predefined sets of outcomes. The single event results in a final and unequivocal outcome of all wagers, and so players are required to re-wager after each event, and no wager relies on the outcome of more than a single event.

U.S. Pat. No. 6,378,869 discloses a dice-based game wherein players wager on the outcome of rolls of two dice followed by the roll of a third die. Disclosed wagers include individual wagers for each possible sum of the dice values as rolled, hi/lo outcome sets (i.e., wagers that the sum of the values rolled will fall within 4 to 10 inclusive or 11 to 17 inclusive) and odd/even outcomes.

Games of chance in the parlor game context may include simulations of casino gaming, as well as point driven and other games not directly related to gambling.

With these considerations in mind, it is desirable to have a game which provides action and excitement for players, has relatively easy to learn rules which do not use complicated rankings of various outcomes, permits a variety of wagers to keep players' interest, has enticing odds to keep players' interest, and builds excitement throughout each game.

### BRIEF SUMMARY OF THE INVENTION

The exemplary embodiments of the present invention have been developed in response to the present state of the art, and in particular, to spark interest and provide entertainment value in games of chance that are easy to learn and administer. The game utilizes multiple random number selectors to generate a point sum, which is the sum of each of the random number selectors. For example, if three random selectors are used and the numbers randomly selected were 1, 7, and 9, the point sum would be 17. Although any type of random number selector may be used, for the purposes of this disclosure and for simplifying the explanation and streamlining the disclosure, the use of standard six-sided dice as the random number selectors will be disclosed. However, it should be understood that other forms of random number selectors, including but not limited to polyhedral, multi-sided dice, randomizing rotating cylinders (such as used in past slot machines), and known random number generators, may be used without departing from the spirit of this invention. For the purposes of this disclosure when dice are used or referenced as the random number selectors, it includes within the definition of dice any type of random number selector that simulates dice by selecting between the numbers 1, 2, 3, 4, 5, and 6 for each selector. Using other forms of random number selectors will require that the odds to be calculated, a task that those skilled in the art could easily perform. For example, if three random number selectors of 1 through 9 are used there are 729 possible point sums allocated among point sums ranging from 3 (1+1+1) to 27 (9+9+9).

Hence, with the use of dice, if four dice are rolled and the numbers 2, 5, 3, and 6 are selected, then the point sum would be 16. If three dice are used, there are 216 possible point sums allocated among point sums ranging from 3 (1+1+1) to 18 (6+6+6). If four dice are used, there are 1296 possible point sums allocated among point sums ranging from 4 (1+1+1+1) to 24 (6+6+6+6). If five dice are used, there are 7776 possible point sums allocated among point sums ranging from 5 (1+1+1+1+1) to 30 (6+6+6+6+6). And so on for using more than five dice or for using random number selectors other than dice. These point sums and the probability of whether a particular point sum will come on any particular roll, is what the players wager upon, in the hope that if the odds are played fortuitously, the player will gain value as oppose to lose value by wagering.

The layout of the game is conducive to game understanding because the layout readily conveys what bets can be made and what odds will pay out for each wager. The game layout comprises a plurality of point-sum zones, a plurality of primary wager zones, a plurality of secondary wager zones, a tertiary wager zone, and a plurality of ancillary wager zones. Each of the wager zones, except for possible special circumstance wager zones (described in detail below), is associated with possible point sums of random number selectors such as dice.

It should be understood that the game layout is conducive to a number of entertainment environments, including but not limited to casino gaming, parlor game entertainment, and personal entertainment. Casino gaming may include both table-based gaming, as well as machine-based gaming, including, for example, mechanical video machine gaming, computer-controlled table-machine gaming, and traditional table-based gaming. The parlor game experience may be a traditional board game or a board game augmented with electronics. Personal gaming may be on a personal computer (web-based or a software purchase from an internet download or retail disk purchase or an app purchase) or may utilize a personal mobile device such as a laptop, a tablet, or a smart phone. Those skilled in the art may easily adapt the exemplary games disclosed herein to any of the above-mentioned entertainment environments without undue experimentation.

Each primary wager zone is disposed adjacent a point-sum zone and by that adjacent juxtaposition is associated to the point sum(s) indicated by point-sum indicia displayed on that particular point-sum zone. For example, if a player placed a wager on the primary wager zone, the wager would be for the point sum(s) indicated in the adjacent point-sum zone. If the point sum rolled matches with a point sum indicated in the point-sum zone associated with the wager placed, that player would win according to the odds indicia indicated in the primary wager zone.

Each secondary wager zone is disposed adjacent at least two point-sum zones and is therefore associated with each adjacent point-sum zone and the point sums indicated in each. For example, if a player placed a wager on a secondary wager zone, the wager would be for all of the point sums indicated in the adjacent point-sum zones. If the point sum rolled matches with any of the point sums indicated in any of the point-sum zones associated with the wager placed, that player would win according to the odds indicia indicated in the secondary wager zone.

The tertiary wager zone is disposed adjacent each of the secondary wager zones and is associated with each adjacent secondary wager zone and the point-sum zones also adjacent to those secondary wager zones. Typically, the tertiary wager zone is associated with all of the point sums indicated in a point-sum zone. For example, if a player placed a wager on the tertiary wager zone, the wager would be for all of the point sums indicated in the point-sum zones. If the point sum rolled matches with any of the point sums indicated in any of the point-sum zones, that player would win according to the odds indicated in the tertiary wager zone.

There also may be ancillary wager zones that are separate and distinct from the primary, secondary, and tertiary wager zones. A first ancillary zone which bears indicia indicating one or more of the point sums. A second ancillary zone also bears indicia indicating one or more of the point sums. Typically, the point sums indicated in the first ancillary zone and the second ancillary zone are the point sums that have the higher probability of occurring and pay out lesser odds. Although, that may not necessarily be the case. If a player placed a wager on the first ancillary zone, the wager would be for all of the point sums indicated in the first ancillary zone. If the point sum rolled matches with any of the point sums indicated in the first ancillary zone, that player would win according to the odds indicated in the first ancillary zone. Similarly, if a player placed a wager on the second ancillary zone, the wager would be for all of the point sums indicated in the second ancillary zone. If the point sum rolled matches with any of the point sums indicated in the second ancillary zone, that player would win according to the odds indicia indicated in the second ancillary zone.

Also, there may be one or more special ancillary zones that are also separate and distinct from the primary, secondary, and tertiary wager zones. For example, one special ancillary zone may be for three of a kind for three-dice embodiments, four of a kind for four-dice embodiments; five of a kind or a full house (three of kind and a pair) for five-dice embodiments. If a player placed a wager on one of the special ancillary zones, the wager would be for whatever special circumstance is indicated in the special ancillary zone. If the rolled dice show the special circumstance (e.g., three of a kind, four of a kind, five of a kind, full house, etc.) corresponding to the special ancillary zone, that player would win according to the odds indicia indicated in the special ancillary zone.

The layout of the game, the pairing of point sums, and the odds selected for the various wagering areas can determine the difficulty of the play, the complexity of the odds determination, the house take, and the level of player interest and entertainment. Various exemplary game layouts will be further explained in the detailed description.

To create additional interest, there are various alternative modes for play. By way of example only, there is a four-dice alternative for play on a five-dice layout. With this alternative, the player places his/her wager on a wager zone and declares either high or low. Then, the four dice are rolled. For illustration purposed, assume the result of rolling the four dice was 3-4-1-6. If the player declared high, then the highest dice is counted twice to arrive at the point sum. In this case, 3+4+1+6+6 for a point of 20. However, if the player declared low, then the lowest dice is counted twice to arrive at the point sum. In that case, 3+4+1+6+1 for a point sum of 15. The wagers are paid out as explained previously.

Yet another alternative way of playing would allow the player to select one dice to re-roll. In a five-dice game, where the initial roll of the dice was 4-2-5-5-5, the player might select the dice indicating “2” to be re-rolled. On the re-roll, if that dice came up “4”, the point sum would be 23 (4+4+5+5+5) and the wagers would be paid out accordingly.

Yet another alternative would be to have one preselected dice to be different (such as a different color or some other distinguishing characteristic). Similar to the high/low alternative, the preselected dice would be added twice to the sum. For example, if the roll was 6-3-1-6 and the preselected dice was the first 6, then the point sum would be 22 (6+3+1+6+6).

Still another variation would be to have the preselected dice be able to replace any dice. In a five-dice game if the roll were 2-5-3-1-3 and the preselected dice was the 2, the player might substitute the 2 for the 5 so that the point sum would become 11 (2+2+3+1+3).

Of course, with these variations on the game, the odds in the various wager zones would have to be adjusted accordingly.

These and other features of the present disclosure will become more fully apparent from the following description, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific exemplary embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 is a plan view of an exemplary game layout with pairings of point sums indicated in the point-sum zones for an embodiment of a three-dice game;

FIG. 2 is a plan view of an exemplary game layout with pairings of point sums indicated in the point-sum zones for an embodiment of a four-dice game;

FIG. 3 is a plan view of an exemplary game layout with pairings of point sums indicated in the point-sum zones for an embodiment of a five-dice game;

FIG. 4 is a plan view of an alternative game layout with pairings of point sums indicated in the point-sum zones for another exemplary embodiment of a five-dice game;

FIG. 5 is a plan view of another exemplary embodiment of a game layout having an electronic aspect and using an alternative relationship indicator and with pairings of point sums indicated in the point-sum zones for a representative embodiment of a three-dice game staged after wager placement and before random point sum determination;

FIG. 6 is a plan view of yet another exemplary embodiment of a game layout having an electronic aspect and using another alternative relationship indicator and with pairings of point sums indicated in the point-sum zones for a representative embodiment of a three-dice game staged after the random point sum determination and the clearing of non-winning wagers, but before winning-wager payout;

FIG. 7 is a plan view of still another exemplary embodiment of a game layout having an electronic aspect and using yet another alternative relationship indicator and with pairings of point sums indicated in the point-sum zones for a different representative embodiment of a three-dice game staged after the random point sum determination and the clearing of non-winning wagers, but before winning-wager payout;

FIG. 8 is a plan view of an exemplary game layout similar to FIG. 1 with pairings of point sums indicated by point-sum indicia in the point-sum zones and odds indicia in the wagering zones for an embodiment of a three-dice game;

FIG. 9 is a flow chart depiction of steps relating to an exemplary embodiment of a Pre-Point Sum Determination portion of the game flow;

FIG. 10 is a flow chart depiction of steps relating to an exemplary embodiment of Point Sum Determination through Wagering Payout; and

FIG. 11 is a schematic depiction of an elevational section of a portion of an exemplary game layout A having various representative electronic aspects provided by various representative components.

### REFERENCE ALPHANUMERICS

| | |
|---|---|
| game layout A | point-sum zones B |
| specific point-sum zone B_{1 . . . n} | primary wager zones C |
| specific primary wager zone C_{1 . . . n} | secondary wager zones D |
| specific secondary wager zone D_{1 . . . n} | tertiary wager zone E |
| ancillary wager zones F | first ancillary wager zone F₁ |
| second ancillary zone F₂ | relationship indicator G |
| flashing light burst FL | |
| (representing flashing highlighting) | |
| dealer bank region H | odds indicia J |
| point-sum indicia K | light burst L (representing highlighting) |
| player home regions P | specific player home regions P₁, P₂, P₃, etc. |
| special ancillary zone S₁ | wager tokens W |
| player wager tokens W₁, W₂, W₃, etc. | neutral wager token Wₙ |
| Pre-Point Sum Determination portion 10 | game readiness query 12 |
| open wagering 14 | ready for play 16 |
| period for wagering 18 | close wagering period 20 |
| read wagered tokens 22 | active wagering zones determination 24 |
| point-sum in play highlighting 26 | data gathering 28 |
| identify and correlate wagers 30 | store per player 32 |
| Point Sum Determination 34 | activate random number selection 35 |
| calculate point sum 36 | de-highlighting non-winning point-sum zones 38 |
| highlighting winning point-sum zone 40 | identifying winning wagering zones 42 |
| clearing non-winning wagering zones 44 | payout calculation 46 |
| payout distribution 48 | clearing extraneous wager tokens 50 |
| wagering zone table portion 52 | wagering zone table portion 53 |
| upper-side surface 54 | underside surface 56 |
| partitioning barriers 58 | specialty sensors 60 |
| light-emitting elements 62, | data gathering element 64 |
| controller 66 | memory storage 68, |
| audio element 70 | reading field 72 |

### DETAILED DESCRIPTION OF THE INVENTION

The presently preferred embodiments of the present invention will be best understood by reference to the drawings, wherein like parts are designated by like designations throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of exemplary embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

For purposes of this disclosure the terms “adjacently abut” or “adjacent abutment” shall mean that two areas or zones share a line, whether linear or curvilinear. Two areas or zones that share only a point are not considered to adjacently abut. Further, areas or zones that adjacently abut by sharing a line, whether linear or curvilinear, define a relationship between the adjacently abutting areas or zones. Hence, such adjacent abutment is included within the scope and meaning of the defined term “relationship indicator” in the sense used and claimed herein. The term “relationship indicator” will be defined herein below.

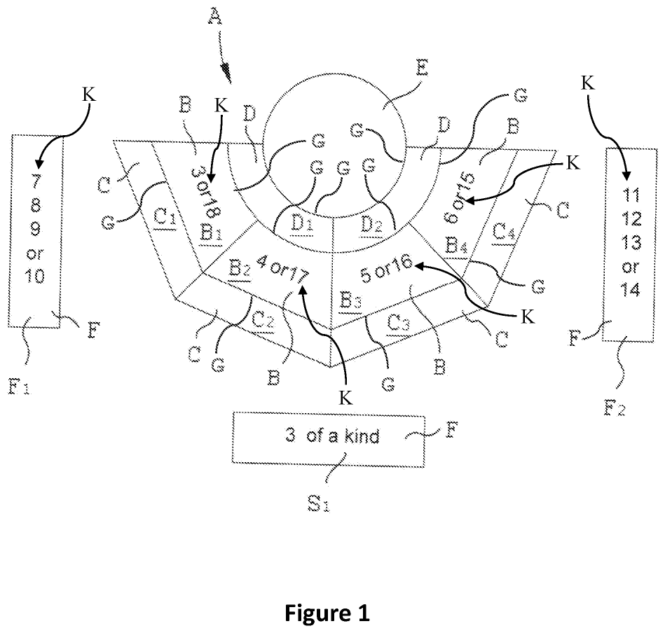

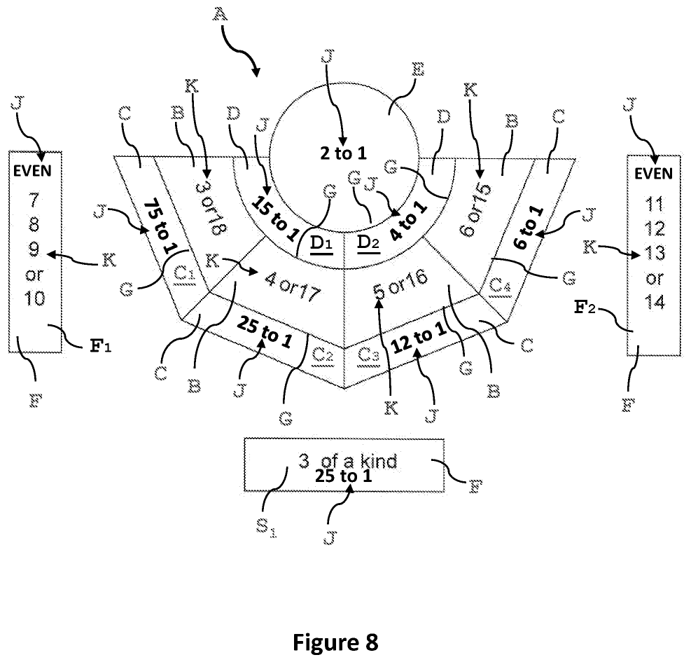

FIG. 1 is a plan view of a game layout for an exemplary embodiment of a three-dice game showing a layout of wagering zones with odds indicia J (not shown in FIG. 1, see FIG. 8) and point-sum zones B with representative point-sum indicia K. The game layout A comprises a plurality of point-sum zones B, a plurality of primary wager zones C, a plurality of secondary wager zones D, a tertiary wager zone E, and a plurality of ancillary wager zones F. As can be seen and by way of example, primary wager zone C₁ adjacently abuts point-sum zone B₁ and primary wager zone C₂ adjacently abuts point-sum zone B₂, but primary wager zone C₁ does not adjacently abut point-sum zone B₂. Adjacent abutment of a wagering zone with a particular point-sum zone B is a relationship indicator G and means that the adjacently abutting wagering zone has a wagering relationship with the point-sum zone it adjacently abuts, for example, primary wager zone C₁ has a wagering relationship with point-sum zone B₁ because it adjacently abuts point-sum zone B₁. Each of point-sum zones B₁, B₂, B₃, and B₄, bears representative point-sum indicia K that is separate and distinct from each other for visually indicating which point sums are associated with each of the respective point-sum zones B₁, B₂, B₃, and B₄.

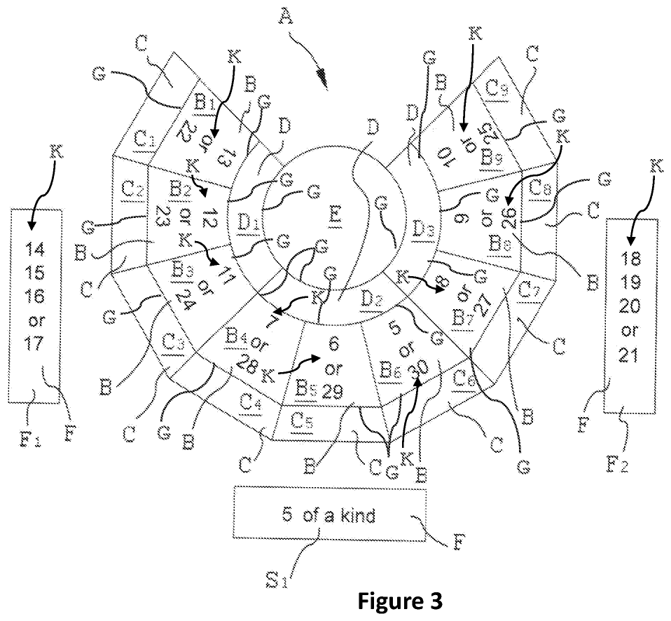

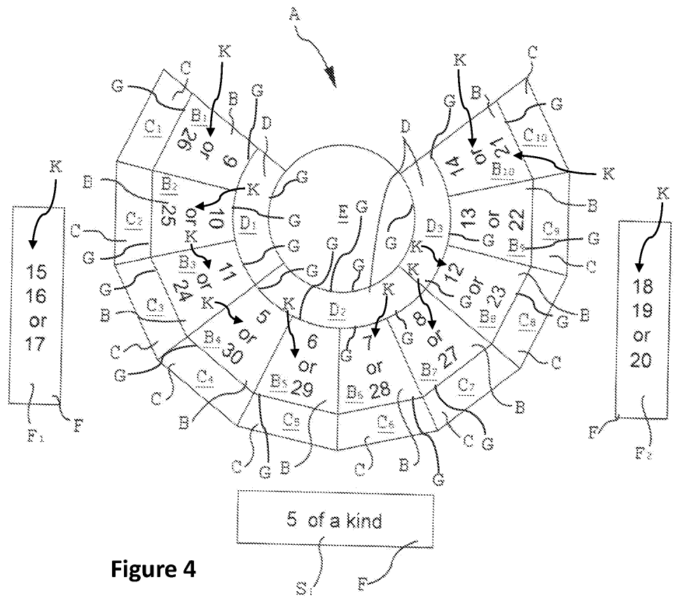

It should be understood that the specific point sums depicted within point-sum zones B₁, B₂, B₃, and B₄ of FIG. 1 are merely exemplary pairings for a game layout for a three-dice game. The arrangement of the point sums may differ in location, pairings, and/or number of point-sum zones (as demonstrated particularly when comparing FIGS. 3 and 4). Those skilled in the calculations of probabilities will readily understand that changing the arrangement of the point sums within point-sum zones B₁, . . . Bₙ may change the desired odds within affected wager zones.

Similarly, secondary wager zone D₁ has a wagering relationship with (sometimes referred to herein as “is associated with”) point-sum zones B₁ and B₂ because secondary wager zone D₁ adjacently abuts both point-sum zones B₁ and B₂. Also, secondary wager zone D₂ has a wagering relationship with point-sum zones B₃ and B₄ because secondary wager zone D₂ adjacently abuts both point-sum zones B₃ and B₄.

Further, tertiary wager zone E is associated with both secondary wager zones D₁, D₂ because tertiary wager zone E adjacently abuts both secondary wager zones D₁, D₂. By that association, tertiary wager zone E has a wagering relationship with each and all of the point-sum zones B₁, B₂, B₃, and B₄. These adjacent abutment relationships indicate which point sums apply to each of the wagering zones among the plurality of primary wager zones C, the plurality of secondary wager zones D, and the tertiary wager zone E.

FIG. 1 also shows exemplary pairings of point sums indicated by point-sum indicia K depicted within the point-sum zones B₁, B₂, B₃, B₄ for the exemplary embodiment of a three-dice game. By way of example, point sums 3 and 18 are indicated in point-sum zone B₁; point sums 4 and 17 are indicated in point-sum zone B₂; point sums 5 and 16 are indicated in point-sum zone B₃; and point sums 6 and 15 are indicated in point-sum zone B₄. As configured, a wager placed on primary wager zone C₁ is a wager that either point sum 3 or point sum 18 will be rolled, and a wager placed on primary wager zone C₂ is a wager that either point sum 4 or point sum 17 will be rolled. Wagers on primary wager zones C₃ and C₄ are handled in the same manner.

Additionally, as configured, a wager placed on secondary wager zone D₁ is a wager that any of point sums 3, 4, 17, or 18 will be rolled, and a wager placed on secondary wager zone D₂ is a wager that any of point sums 5, 6, 15, or 16 will be rolled. Accordingly, a wager placed on tertiary wager zone E is a wager that any of point sums 3, 4, 5, 6, 15, 16, 17, or 18 will be rolled. Of course, the exemplary embodiment shown in FIG. 1 is only an example of one configuration of the game layout A. The point sum pairings, the arrangement of the point sum pairings, the geometric layout of the various zones, and the selections of which point sums are depicted within point-sum zones B could all differ from what is shown in Chart 1, below, without departing from the spirit and scope of the invention. In such case, the probabilities and odds shown in Chart 1 would differ accordingly. The probabilities and break-even indicator shown in Chart 1 are for the particular exemplary configuration shown in FIG. 1 and demonstrate a methodology for selecting pairings and determining betting odds.

Turning now to the ancillary wager zones F of FIG. 1, ancillary wager zones F are ancillary to the main portion of the game layout A and may comprise first ancillary wager zone F₁, second ancillary zone F₂, and special ancillary zone S₁. In the configuration shown, first ancillary zone F₁ has point sums 7, 8, 9, and 10 depicted therein, and second ancillary zone F₂ has point sums 11, 12, 13, and 14 depicted therein. As a result, a wager placed on the first ancillary wager zone F₁ is a wager that any of point sums 7, 8, 9, or 10 will be rolled, and a wager placed on second ancillary wager zone F₂ is a wager that any of point sums 11, 12, 13, or 14 will be rolled. Of course, the exemplary embodiment shown in FIG. 1 is only an example of one configuration of the game layout A. The number of ancillary wager zones, the size and geometric layout of the ancillary zones, and the selections of which point sums are placed in ancillary wager zones could all differ from what is shown without departing from the spirit and scope of the invention. In such cases, the probabilities and odds shown in Chart 1 would differ accordingly. The probabilities and break-even indicators shown in Chart 1 are for the particular exemplary configuration shown in FIG. 1.

A single special ancillary wage zone S₁ is shown in FIG. 1 and is designated as a “3 of a kind” special outcome. Hence, a wager placed on special ancillary wager zone S₁ is a wager that all three dice will come up the same when rolled. In this special instance, point sum is not relevant to such a wager. Rather, the special circumstance must occur for there to be a payout on such a wager. Although only one special ancillary wager zone is shown, others are contemplated and may be used, such as a three dice straight (1-2-3, or 2-3-4, or 3-4-5, or 4-5-6) or any other special circumstance. The number of special ancillary wager zones, the size and geometric layout of the special ancillary zones, and the selections of which special circumstances are indicated in special ancillary wager zones could all differ from what is shown without departing from the spirit and scope of the invention. In such cases, the probabilities and break-even indicator shown in Chart 1 would differ accordingly. The probabilities and break-even indicators shown in Chart 1 are for the particular exemplary configuration shown in FIG. 1.

CHART 1

| Wager | | Probability | Percent | Break-even |
|---|---|---|---|---|
| Zone | Point Sums | Count | Probability | Indicator |
| C₁ | 3 or 18 | 2 | 0.926% | 106.99136 |
| C₂ | 4 or 17 | 6 | 2.778% | 34.99712 |
| C₃ | 5 or 16 | 12 | 5.556% | 16.99856 |
| C₄ | 6 or 15 | 20 | 9.259% | 9.8003 |
| D₁ | 3, 4, 17, or 18 | 8 | 3.704% | 25.99784 |
| D₂ | 5, 6, 15, or 16 | 32 | 14.815% | 5.74992 |
| E | 3, 4, 5, 6, 15, 16, | 40 | 18.519% | 4.39986 |
| | 17, or 18 | | | |
| F₁ | 7, 8, 9, or 10 | 88 | 40.741% | 1.45453 |
| F₂ | 11, 12, 13, or 14 | 88 | 40.741% | 1.45453 |
| S₁ | 3 of a kind | 6 | 2.778% | 34.99712 |

Chart 1 shows exemplary pairings of point sums as depicted within the various point-sum zones B and indications of the probability counts, probability percentages, and break-even indicators for the exemplary embodiment of a three-dice game. The integer depicted in the “probability count” column represents how many combinations out of the total number of combinations (216 combinations in the three-dice embodiment) are associated with the designated point sums. The percentage depicted in the “probability percentage” is the number of combinations associated with the designated point sums divided by 216. The decimal number depicted in the “break-even indicator” column may be used to determine odds. For example, the probability count for primary wager zone C₁ is 2 and this means that averaging over time for every 216 rolls of the dice, the point sum will be either 3 or 18 twice. The probability count of 2 represents 0.926% of the rolls of the dice (i.e., 2 divided by 216), and the decimal number 106.99136 represents that if the odds were placed at 106.99136 to 1, then the house would break even over time. The break-even indicator is calculated by subtracting the probability percentage from 100% (in this instance, 100%−0.926%=99.074%) and then dividing the result (99.074%) by the probability percentage (99.07% divided by 0.926%=106.99136). The closer the odds are set to 106.99136 to 1, the less value the house gains and the longer a player will survive playing the game given a finite stake to begin without adding to the stake.

Similarly, the probability count for tertiary wager zone E is 40, meaning that averaging over time for every 216 rolls of the dice, the point sum will be either 3, 4, 5, 6, 15, 16, 17, or 18 forty times, the probability percentage is 18.519% and the break-even indicator is 4.39986. Also, the probability count for first ancillary wager zone F₁ is 88, meaning that averaging over time for every 216 rolls of the dice, the point sum will be either 7, 8, 9, or 10 eighty-eight times, the probability percentage is 40.741% and the break-even indicator is 1.45453. Additionally, for the configuration shown in FIG. 1, the probability count for special ancillary wager zone S₁ is 6, meaning that averaging over time for every 216 rolls of the dice, all three dice will be the same six times, the probability percentage is 2.778% and the break-even indicator is 34.99712.

For the sake of brevity and streamlining this disclosure, the determination and calculation of the probability count, the probability percentage, and the break-even indicator will not be repeated for each wagering zone. The probability percentage and the break-even indicator may be calculated in the same fashion for each wagering zone. Moreover, if a different configuration is used, once the probability count is determined for a particular wager zone, the probability percentage and the break-even indicator for that wager zone may be calculated in the same fashion.

Additionally, so not to overcrowd the drawings with additional numbers, reference alphanumerics, and lead lines, FIGS. 1-7 do not show odds indicia J within the wagering zones. Rather, FIG. 8 is provided as a representative exemplar of FIG. 1 with exemplary odds indicia J shown as taken from the odds alternatives depicted in Chart 2 below. FIG. 8 also serves as a representative exemplar for other game layouts contemplated by this disclosure. It should be understood the odds indicia J may differ for each wagering zone in each game layout, and that a skilled artisan, armed with the information provided in this disclosure, will be able to calculate and select the odds desired.

Turning now to Chart 2, the alternative possible odds and the house take value for each indicated odds alternative for each wager zone are shown for the exemplary embodiment of a three-dice game. The representative odds alternatives depicted represent example odds settings that are lower than the break-even odds indicator from Chart 1, and the decimal number following each potential odds setting represents a relative indicator of how much the house stands to gain over time (herein identified as the “house take value”) for each wagering zone.

CHART 2

| Wager | | Odds | House Take |
|---|---|---|---|
| Zone | Point Sums | Alternatives | Values |
| C₁ | 3 or 18 | 50 to 1 | 52.774 |
| | | 75 to 1 | 29.624 |
| | | 100 to 1 | 6.474 |
| C₂ | 4 or 17 | 25 to 1 | 27.772 |
| | | 30 to 1 | 13.882 |
| C₃ | 5 or 16 | 12 to 1 | 27.772 |
| | | 15 to 1 | 11.104 |
| C₄ | 6 or 15 | 6 to 1 | 35.187 |
| | | 8 to 1 | 16.669 |
| D₁ | 3, 4, 17, or 18 | 15 to 1 | 40.736 |
| | | 20 to 1 | 22.216 |
| | | 24 to 1 | 7.400 |
| D₂ | 5, 6, 15, or 16 | 4 to 1 | 25.925 |
| | | 5 to 1 | 11.110 |
| E | 3, 4, 5, 6, 15, 16, | 2 to 1 | 44.443 |
| | 17, or 18 | 3 to 1 | 25.924 |
| | | 4 to 1 | 7.405 |
| F₁ | 7, 8, 9, or 10 | Even | 18.518 |
| F₂ | 11, 12, 13, or 14 | Even | 18.518 |
| S₁ | 3 of a kind | 25 to 1 | 27.772 |
| | | 30 to 1 | 13.882 |

For example, the exemplary potential odds settings for primary wager zone C₁ are 50 to 1, 75 to 1, and 100 to 1 (each being lower than the break-even indicator for primary wager zone C₁ shown in Chart 1 as 106.99136). For each of the potential odds settings 50 to 1, 75 to 1, and 100 to 1, the house take value is 52.774, 29.624, and 6.474, respectively. The house take value for the 50 to 1 odds setting is calculated as follows: 1) Multiply the probability percentage (0.926%) by 50 to arrive at an odds augmented percentage (50×0.926%=46.300%); 2) Subtract the probability percentage from 100% to arrive at an interim result (100%−0.926%=99.074%); and 3) Subtract the odds augmented percentage from the interim result to arrive at the house take value (expressed without the percentage indicator) (99.074%−46.300%=52.774). The house take value can be calculated in a similar fashion for each of the potential odds depicted for each wagering zone. The closer the house take value is to zero, the less value the house gains and the longer a player will survive playing the game given a finite stake to begin without adding to the stake.

Similarly, the exemplary possible odds settings for tertiary wager zone E are 2 to 1, 3 to 1, and 4 to 1 (each being lower than the break-even indicator for tertiary wager zone E shown in FIG. 3 as 4.39986). For each of the potential odds settings 2 to 1, 3 to 1, and 4 to 1, the house take value is 44.443, 25.924, and 7.405, respectively. Also, the possible odds settings for first ancillary wager zone F₁ is “even odds” with a house take value of 18.518. Additionally, for the configuration shown in FIG. 1, the possible odds settings for special ancillary wager zone S₁ are 25 to 1 and 30 to 1, for house take values of 27.772 and 13.882, respectively.

For the sake of brevity and streamlining this disclosure, the calculation of the house take value for each potential odds setting will not be repeated for each wagering zone. The house take value for each potential odds setting may be calculated in the same fashion for each wagering zone. Moreover, if a different configuration is used, once the probability count is determined and the odds are set for a particular wager zone, the house take value for that wager zone can be calculated in the same fashion.

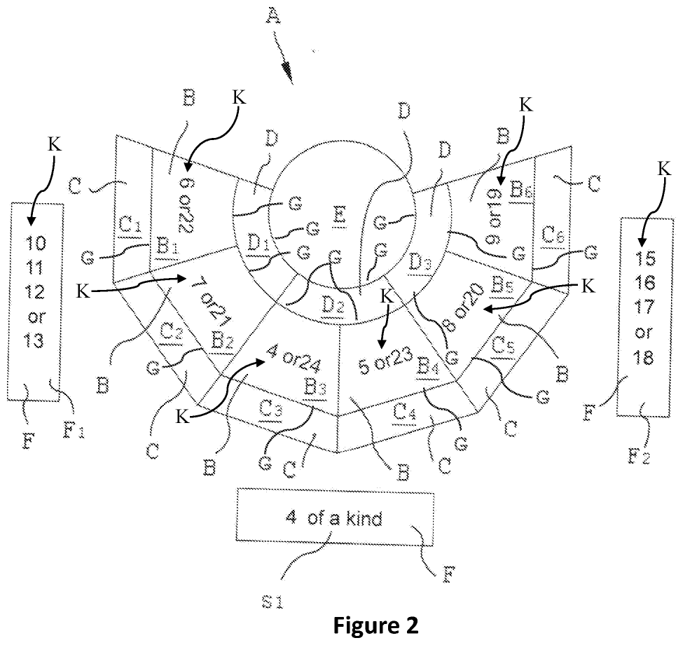

Similar to FIG. 1, FIG. 2 is a plan view of a game layout but for an exemplary embodiment of a four-dice game rather than a three-dice game, showing a layout of wagering zones and point-sum zones. The game layout A comprises a plurality of point-sum zones B, a plurality of primary wager zones C, a plurality of secondary wager zones D, a tertiary wager zone E, and a plurality of ancillary wager zones F. As can be seen and by way of example, primary wager zone C₁ adjacently abuts point-sum zone B₁ and primary wager zone C₂ adjacently abuts point-sum zone B₂, but primary wager zone C₁ does not adjacently abut point-sum zone B₂. Again, adjacent abutment of a wagering zone with a particular point-sum zone B defines a wagering relationship identified by a relationship indicator G and means that the adjacently abutting wagering zone has a wagering relationship with the point-sum zone B it adjacently abuts, for example, primary wager zone C₁ has a wagering relationship with point-sum zone B₁ because it adjacently abuts point-sum zone B₁.

Similarly, secondary wager zone D₁ has a wagering relationship with point-sum zones B₁ and B₂ because secondary wager zone D₁ adjacently abuts both point-sum zones B₁ and B₂. Also, secondary wager zone D₂ has a wagering relationship with point-sum zones B₃ and B₄ because secondary wager zone D₂ adjacently abuts both point-sum zones B₃ and B₄. Secondary wager zone D₃ has a wagering relationship with point-sum zones B₅ and B₆ because secondary wager zone D₃ adjacently abuts both point-sum zones B₅ and B₆. Further, tertiary wager zone E has a wagering relationship with secondary wager zones D₁, D₂, D₃ because tertiary wager zone E adjacently abuts secondary wager zones D₁, D₂, D₃. By that association, tertiary wager zone E has a wagering relationship with all of the point-sum zones B₁, B₂, B₃, B₄, B₅, B₆. These wagering relationships indicate which point sums apply to each of the wagering zones among the plurality of primary wager zones C, the plurality of secondary wager zones D, and the tertiary wager zone E.

Exemplary pairings of point sums indicated in the point-sum zones B for the exemplary embodiment of a four-dice game are shown in FIG. 2. Point sums 6 and 22 are depicted by point-sum indicia K in point-sum zone B₁; point sums 7 and 21 are depicted by point-sum indicia K in point-sum zone B₂; point sums 4 and 24 are indicated in point-sum zone B₃; point sums 5 and 23 are depicted by point-sum indicia K in point-sum zone B₄; point sums 8 and 20 are depicted by point-sum indicia K in point-sum zone B₅; and point sums 9 and 19 are depicted by point-sum indicia K in point-sum zone B₆. As configured, a wager placed on primary wager zone C₁ is a wager that either point sum 6 or point sum 22 will be rolled, and a wager placed on primary wager zone C₂ is a wager that either point sum 7 or point sum 21 will be rolled. Wagers on primary wager zones C₃, C₄, C₅, and C₆ are handled in the same manner.

Additionally, as configured, a wager placed on secondary wager zone D₁ is a wager that any of point sums 6, 7, 21, or 22 will be rolled, and a wager placed on secondary wager zone D₂ is a wager that any of point sums 4, 5, 23, or 24 will be rolled. Accordingly, a wager placed on tertiary wager zone E is a wager that any of point sums 4, 5, 6, 7, 8, 9, 19, 20, 21, 22, 23, or 24 will be rolled. Of course, the exemplary embodiment shown in FIG. 2 is only an example of one configuration of the game layout A. The point sum pairings, the arrangement of the point sum pairings, the geometric layout of the various zones, and the selections of which point sums are placed in point-sum zones B could all differ from what is shown without departing from the spirit and scope of the invention. In such case, the probabilities and odds shown in Chart 3 below would differ accordingly. The probabilities and break-even indicators shown in Chart 3 are for the particular exemplary configuration shown in FIG. 2.

CHART 3

| Wager | | Probability | Percent | Break-even |
|---|---|---|---|---|
| Zone | Point Sums | Count | Probability | Indicator |
| C₁ | 6 or 22 | 20 | 1.543% | 63.80881 |
| C₂ | 7 or 21 | 40 | 3.086% | 31.40441 |
| C₃ | 4 or 24 | 2 | 0.154% | 648.35065 |
| C₄ | 5 or 23 | 8 | 0.617% | 161.07455 |
| C₅ | 8 or 20 | 70 | 5.401% | 17.51509 |
| C₆ | 9 or 19 | 112 | 8.642% | 10.57140 |
| D₁ | 6, 7, 21 or 22 | 60 | 4.63% | 20.59827 |
| D₂ | 4, 5, 23, or 24 | 10 | 0.772% | 128.53368 |
| D₃ | 8, 9, 19, or 20 | 182 | 14.043% | 6.12099 |
| E | 4, 5, 6, 7, 8, 9, 19, | 252 | 19.444% | 4.14297 |
| | 20, 21, 22, 23, or 24 | | | |
| F₁ | 10, 11, 12, or 13 | 449 | 34.645% | 1.88642 |
| F₂ | 15, 16, 17, or 18 | 449 | 34.645% | 1.88642 |
| S₁ | 4 of a kind | 6 | 0.463% | 214.98272 |

Ancillary wager zones F are ancillary to the central portion of the game layout A and may comprise first ancillary wager zone F₁, second ancillary zone F₂, and special ancillary zone S₁. In the configuration shown, first ancillary zone F₁ has point sums 10, 11, 12, and 13 depicted therein, and second ancillary zone F₂ has point sums 15, 16, 17, and 18 depicted therein. As a result, a wager placed on the first ancillary wager zone F₁ is a wager that any of point sums 10, 11, 12, and 13 will be rolled, and a wager placed on second ancillary wager zone F₂ is a wager that any of point sums 15, 16, 17, and 18 will be rolled. Further, with the depicted configuration, the point sum 14 is a bust (i.e., if the sum 14 is rolled, no wagers win). Of course, the exemplary embodiment shown in FIG. 2 is only an example of one configuration of the game layout A. The number of ancillary wager zones F, the size and geometric layout of the ancillary wager zones F, and the selections of which point sums are depicted in ancillary wager zones F could all differ from what is shown without departing from the spirit and scope of the invention. For example, there may be three non-special ancillary wager zones F each with three different point sums displayed therein. In which case, the point sum 14 could be used and not be a bust. In such alternative cases, the probabilities and odds would differ accordingly. The probabilities and odds shown in Charts 3 and 4 are for the particular exemplary configuration shown in FIG. 2.

A single special ancillary wage zone S₁ is shown in FIG. 2 and is designated as a “4 of a kind” special outcome. Hence, a wager placed on special ancillary wager zone S₁ is a wager that all four dice will come up the same when rolled. In this special instance, point sum is not relevant to such a wager. Rather, the special circumstance must occur for there to be a payout on such a wager. Although only one special ancillary wager zone S₁ is shown, others are contemplated and may be used, such as a four dice straight (1-2-3-4, or 2-3-4-5, or 3-4-5-6), two pair (e.g., 1-1-3-3 or 2-2-6-6), or any other special circumstance. The number of special ancillary wager zones S₁, the size and geometric layout of the special ancillary zones S₁, and the selections of which special circumstances are indicated within the special ancillary wager zones S₁ may all differ from what is shown without departing from the spirit and scope of the invention. In such cases, the probabilities and odds shown in Charts 3 and 4 would differ accordingly. The probabilities and odds shown in Charts 3 and 4 are for the particular exemplary configuration shown in FIG. 2.

In Chart 3, three informational aspects are depicted for each wagering zone. The integer depicted represents the probability count, the percentage depicted is the probability percentage, and the decimal number depicted is the break-even indicator for each wagering zone. For example, the probability count for primary wager zone C₁ is 20 and this means that averaging over time for every 1296 rolls of the dice, the point sum will be either 6 or 22 twenty times. The probability count of 20 represents 1.543% of the rolls of the dice (i.e., 20 divided by 1296), and the decimal number 63.80881 represents that if the odds were placed at 63.80881 to 1, then the house would break even over time. The break-even indicator is calculated by subtracting the probability percentage from 100% (in this instance, 100%−1.543%=98.457%) and then dividing the result (98.457%) by the probability percentage (98.457% divided by 1.543%=63.80881). The closer the odds are set to 63.80881 to 1, the less value the house gains and the longer a player will survive playing the game given a finite stake to begin without adding to the stake.

Similarly, the probability count for tertiary wager zone E is 252, meaning that averaging over time for every 1296 rolls of the dice, the point sum will be either 4, 5, 6, 7, 8, 9, 19, 20, 21, 22, 23, or 24 two hundred fifty-two times, the probability percentage is 19.444% and the break-even indicator is 4.14297. Also, the probability count for first ancillary wager zone F₁ is 449, meaning that averaging over time for every 1296 rolls of the dice, the point sum will be either 10, 11, 12, or 13 four hundred forty-nine times, the probability percentage is 34.645% and the break-even indicator is 1.88642. Additionally, for the configuration shown in FIG. 2, the probability count for special ancillary wager zone S₁ is 6, meaning that averaging over time for every 1296 rolls of the dice, all four dice will be the same six times, the probability percentage is 0.463% and the break-even indicator is 214.98272.

For the sake of brevity and streamlining this disclosure, the determination and calculation of the probability count, the probability percentage, and the break-even indicator will not be repeated for each wagering zone. The probability percentage and the break-even indicator may be calculated in the same fashion for each wagering zone. Moreover, if a different configuration is used, once the probability count is determined for a particular wager zone, the probability percentage and the break-even indicator for that wager zone may be calculated in the same fashion.

Turning now to Chart 4, Chart 4 shows exemplary pairings of point sums indicated by point-sum indicia K in the point-sum zones B, indications of alternative possible odds, and the house take value for each indicated odds alternative for the exemplary embodiment of a four-dice game. Two informational aspects are depicted for each wagering zone. The representative odds alternatives depicted represent example odds settings that are lower than the break-even odds indicator from Chart 3, and the decimal number following each potential odds setting represents a relative indicator of how much the house stands to gain over time (i.e., the house take value) for each wagering zone.

CHART 4

| Wager | | Odds | House Take |
|---|---|---|---|
| Zone | Point Sums | Alternatives | Values |
| C₁ | 6 or 22 | 50 to 1 | 21.307 |
| | | 60 to 1 | 5.877 |
| C₂ | 7 or 21 | 25 to 1 | 19.764 |
| | | 30 to 1 | 4.334 |
| C₃ | 4 or 24 | 500 to 1 | 22.846 |
| | | 600 to 1 | 7.446 |
| C₄ | 5 or 23 | 125 to 1 | 22.258 |
| | | 150 to 1 | 6.833 |
| C₅ | 8 or 20 | 12 to 1 | 29.787 |
| | | 15 to 1 | 13.584 |
| C₆ | 9 or 19 | 8 to 1 | 22.220 |
| | | 10 to 1 | 4.938 |
| D₁ | 6, 7, 21 or 22 | 15 to 1 | 25.920 |
| | | 20 to 1 | 2.770 |
| D₂ | 4, 5, 23, or 24 | 100 to 1 | 22.028 |
| | | 120 to 1 | 6.588 |
| | | 125 to 1 | 2.728 |
| D₃ | 8, 9, 19, or 20 | 4 to 1 | 29.785 |
| | | 5 to 1 | 15.742 |
| | | 6 to 1 | 1.699 |
| E | 4, 5, 6, 7, 8, 9, 19, 20, | 2 to 1 | 41.668 |
| | 21, 22, 23, or 24 | 3 to 1 | 22.224 |
| | | 4 to 1 | 2.780 |
| F₁ | 10, 11, 12, or 13 | Even | 30.710 |
| | | 3 to 2 | 17.3225 |
| F₂ | 15, 16, 17, or 18 | Even | 30.710 |
| | | 3 to 2 | 17.3225 |
| S₁ | 4 of a kind | 200 to 1 | 10.641 |
| | | 175 to 1 | 18.512 |

For example, the exemplary potential odds settings for primary wager zone C₁ are 50 to 1 and 60 to 1 (each being lower than the break-even indicator for primary wager zone C₁ shown in Chart 3 as 63.80881). For the odds settings 50 to 1 and 60 to 1, the house take value is 21.307 and 5.877, respectively. The house take value for the 50 to 1 odds setting is calculated as explained above with respect to the three-dice configuration. Again, the closer the house take value is to zero, the less value the house gains and the longer a player will survive playing the game given a finite stake to begin without adding to the stake.

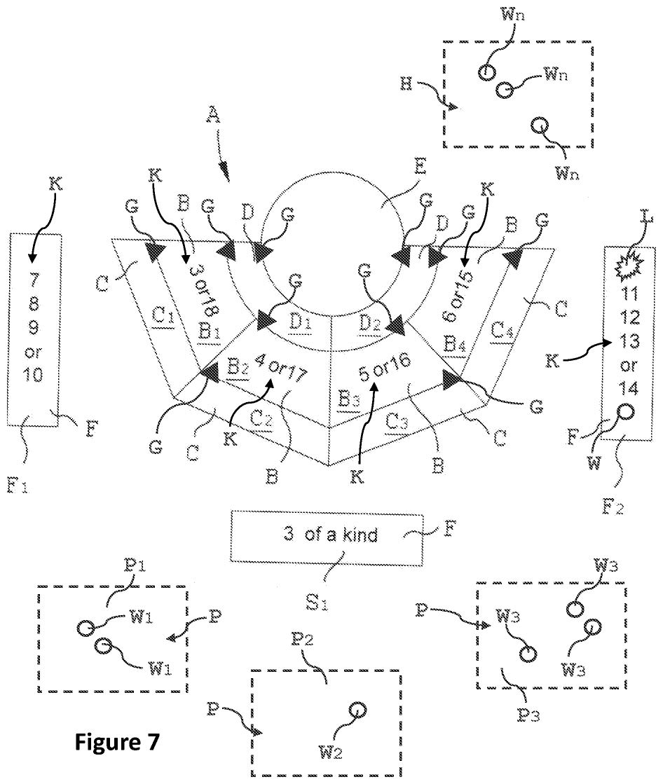

Similarly, the exemplary potential odds settings for tertiary wager zone E are 2 to 1, 3 to 1, and 4 to 1 (each being lower than the break-even indicator for tertiary wager zone E shown in FIG. 7 as 4.14297). For the odds settings 2 to 1, 3 to 1, and 4 to 1, the house take value is 41.668, 22.224, and 2.780, respectively. Also, the odds settings for first ancillary wager zone F₁ is “even odds” and 3 to 2 with a house take value of 30.710 and 17.3225, respectively. Additionally, for the configuration shown in FIG. 2, the exemplary potential odds settings for special ancillary wager zone S₁ are 175 to 1 and 200 to 1, for house take values of 18.512 and 10.641, respectively.

Again, for the sake of brevity and streamlining this disclosure, the calculation of the house take value for each potential odds setting will not be repeated for each wagering zone. The house take value for each potential odds setting may be calculated in the same fashion for each wagering zone. Moreover, if a different configuration is used, once the probability count is determined and the odds are set for a particular wager zone, the house take value for that wager zone can be calculated in the same fashion.

Similar to FIGS. 1 and 2, FIG. 3 is a plan view of a game layout for an exemplary embodiment of a five-dice game, rather than three-dice and four-dice games showing a layout of wagering zones and point-sum zones. The game layout A comprises a plurality of point-sum zones B, a plurality of primary wager zones C, a plurality of secondary wager zones D, a tertiary wager zone E, and a plurality of ancillary wager zones F. As depicted and by way of example, primary wager zone C₁ adjacently abuts point-sum zone B₁ and primary wager zone C₂ adjacently abuts point-sum zone B₂, but primary wager zone C₁ does not adjacently abut point-sum zone B₂. Adjacent abutment of a wagering zone with a particular point-sum zone B defines a wagering relationship identified by a relationship indicator G and means that the adjacently abutting wagering zone has a wagering relationship with the point-sum zone it adjacently abuts, for example, primary wager zone C₁ is associated with point-sum zone B₁ because it adjacently abuts point-sum zone B₁.

Similarly, secondary wager zone D₁ is associated with point-sum zones B₁, B₂, and B₃ because secondary wager zone D₁ adjacently abuts point-sum zones B₁, B₂, and B₃. Also, secondary wager zone D₂ is associated with point-sum zones B₄, B₅, and B₆ because secondary wager zone D₂ adjacently abuts point-sum zones B₄, B₅, and B₆. Further, tertiary wager zone E is associated with secondary wager zones D₁, D₂, D₃ because tertiary wager zone E adjacently abuts secondary wager zones D₁, D₂, D₃. By that association, tertiary wager zone E is associated with all of the point-sum zones B₁, B₂, B₃, B₄, B₅, B₆, B₇, B₈, B₉. These associations indicate which point sums apply to each of the wagering zones among the plurality of primary wager zones C, the plurality of secondary wager zones D, and the tertiary wager zone E.

FIG. 3 shows exemplary pairings of point sums indicated in nine point-sum zones for the exemplary embodiment of a five-dice game. Point sums 13 and 22 are indicated in point-sum zone B₁; point sums 12 and 23 are indicated in point-sum zone B₂; point sums 11 and 24 are indicated in point-sum zone B₃; point sums 7 and 28 are indicated in point-sum zone B₄, point sums 6 and 29 are indicated in point-sum zone B₅; point sums 5 and 30 are indicated in point-sum zone B₆, point sums 8 and 27 are indicated in point-sum zone B₇, point sums 9 and 26 are indicated in point-sum zone B₈; and point sums 10 and 25 are indicated in point-sum zone B₉. As configured, a wager placed on primary wager zone C₁ is a wager that either point sum 13 or point sum 22 will be rolled, and a wager placed on primary wager zone C₂ is a wager that either point sum 12 or point sum 23 will be rolled. Wagers on primary wager zones C₃, C₄, C₅, C₆, C₇, C₈, and C₉ are handled in the same manner.

Additionally, as configured, a wager placed on secondary wager zone D₁ is a wager that any of point sums 11, 12, 13, 22, 23, or 24 will be rolled, and a wager placed on secondary wager zone D₂ is a wager that any of point sums 5, 6, 7, 28, 29, or 30 will be rolled. Accordingly, a wager placed on tertiary wager zone E is a wager that any of point sums 5, 6, 7, 8, 9, 10, 11, 12, 13, 22, 23, 24, 25, 26, 27, 28, 29, or 30 will be rolled. Of course, the exemplary embodiment shown in FIG. 3 is only an example of one configuration of the game layout A. The point sum pairings, the arrangement of the point sum pairings, the geometric layout of the various zones, and the selections of which point sums are placed in point-sum zones could all differ from what is shown without departing from the spirit and scope of the invention. In such case, the probabilities and break-even indicators shown in Chart 5, below, would differ accordingly. The probabilities and break-even indicators shown in Chart 5 are for the particular exemplary configuration shown in FIG. 3.

CHART 5

| Wager | | Probability | Percent | Break-even |
|---|---|---|---|---|
| Zone | Point Sums | Count | Probability | Indicator |
| C₁ | 13 or 22 | 840 | 10.802% | 8.25754 |
| C₂ | 12 or 23 | 610 | 7.845% | 11.74697 |
| C₃ | 11 or 24 | 410 | 5.273% | 17.96454 |
| C₄ | 7 or 28 | 30 | 0.386% | 258.06736 |
| C₅ | 6 or 29 | 10 | 0.129% | 774.1938 |
| C₆ | 5 or 30 | 2 | 0.026% | 3,845.15385 |
| C₇ | 8 or 27 | 70 | 0.9% | 110.11111 |
| C₈ | 9 or 26 | 140 | 1.8% | 54.5556 |
| C₉ | 10 or 25 | 252 | 3.241% | 29.85467 |
| D₁ | 11, 12, 13, 22, 23, | 1860 | 23.92% | 3.1806 |
| | or 24 | | | |
| D₂ | 5, 6, 7, 28, 29, or | 42 | 0.54% | 184.18519 |
| | 30 | | | |
| D₃ | 8, 9, 10, 25, 26, or | 462 | 5.941% | 15.83218 |
| | 27 | | | |
| E | 5, 6, 7, 8, 9, 10, 11, | 2364 | 30.401% | 2.28937 |
| | 12, 13, 22, 23, 24, | | | |
| | 25, 26, 27, 28, 29, | | | |
| | or 30 | | | |
| F₁ | 14, 15, 16, or 17 | 2706 | 34.799% | 1.87365 |
| F₂ | 18, 19, 20, or 21 | 2706 | 34.799% | 1.87365 |
| S₁ | 5 of a kind | 6 | 0.077% | 1297.7013 |

Ancillary wager zones F are ancillary to the central portion of the game layout A and may comprise first ancillary wager zone F₁, second ancillary zone F₂, and special ancillary zone S₁. In the configuration shown, first ancillary zone F₁ has point sums 14, 15, 16, and 17 depicted therein, and second ancillary zone F₂ has point sums 18, 19, 20, and 21 depicted therein. As a result, a wager placed on the first ancillary wager zone F₁ is a wager that any of point sums 14, 15, 16, and 17 will be rolled, and a wager placed on second ancillary wager zone F₂ is a wager that any of point 18, 19, 20, and 21 will be rolled. Of course, the exemplary embodiment shown in FIG. 3 is only an example of one configuration of the game layout A. The number of ancillary wager zones F, the size and geometric layout of the ancillary wager zones F, and the selections of which point sums are displayed in ancillary wager zones F could all differ from what is shown without departing from the spirit and scope of the invention. In such alternative cases, the probabilities and break-even indicators shown in Chart 5 would differ accordingly.

A single special ancillary wage zone S₁ is shown in FIG. 3 and is designated as a “5 of a kind” special outcome. Hence, a wager placed on special ancillary wager zone S₁ is a wager that all five dice will come up the same when rolled. In this special instance, point sum is not relevant to such a wager. Rather, the special circumstance must occur for there to be a payout on such a wager. Although only one special ancillary wager zone S₁ is shown, others are contemplated and may be used, such as a five dice straight (1-2-3-4-5 or 2-3-4-5-6), a full house (e.g., 1-1-1-3-3 or 2-2-2-6-6), or any other special circumstance. The number of special ancillary wager zones S₁, the size and geometric layout of the special ancillary zones S₁, and the selections of which special circumstances are indicated within the special ancillary wager zones S₁ may all differ from what is shown without departing from the spirit and scope of the invention. In such cases, the probabilities and break-even indicators shown in Chart 5 would differ accordingly.

Chart 5 shows exemplary pairings of point sums indicated in the point-sum zones B of FIG. 3, as well as indications of the probability counts, probability percentages, and break-even indictors for the exemplary embodiment of a five-dice game. The integer depicted represents the probability count, the percentage depicted is the probability percentage, and the decimal number depicted is the break-even indicator for each wagering zone. For example, the probability count for primary wager zone C₁ is 840 and this means that averaging over time for every 7776 rolls of the dice, the point sum will be either 13 or 22 eight hundred forty times. The probability count of 840 represents 10.802% of the rolls of the dice (i.e., 840 divided by 7776), and the decimal number 8.25754 represents that if the odds were placed at 8.25754 to 1, then the house would break even over time. The break-even indicator is calculated by subtracting the probability percentage from 100% (in this instance, 100%−10.802%=89.198%) and then dividing the result (89.198%) by the probability percentage (89.1987% divided by 10.802%=8.25754). The closer the odds are set to 8.25754 to 1, the less value the house gains and the longer a player will last playing the game given a finite stake to begin without adding to the stake.

Similarly, the probability count for tertiary wager zone E is 2,364, meaning that averaging over time for every 7776 rolls of the dice, the point sum will be 5, 6, 7, 8, 9, 10, 11, 12, 13, 22, 23, 24, 25, 26, 27, 28, 29, or 30 two thousand three hundred sixty-four times, the probability percentage is 30.401% and the break-even indicator is 2.28937. Also, the probability count for first ancillary wager zone F₁ is 2706, meaning that averaging over time for every 7776 rolls of the dice, the point sum will be either 14, 15, 16, or 17 two thousand seven hundred six times, the probability percentage is 34.799% and the break-even indicator is 1.87365. Additionally, for the configuration shown in FIG. 3, the probability count for special ancillary wager zone S₁ is 6, meaning that averaging over time for every 7776 rolls of the dice, all five dice will be the same six times, the probability percentage is 0.077% and the break-even indicator is 1,297.7013.

For the sake of brevity and streamlining this disclosure, the determination and calculation of the probability count, the probability percentage, and the break-even indicator will not be repeated for each wagering zone. The probability percentage and the break-even indicator may be calculated in the same fashion for each wagering zone. Moreover, if a different configuration is used, once the probability count is determined for a particular wager zone, the probability percentage and the break-even indicator for that wager zone may be calculated in the same fashion.

Turning now to Chart 6, exemplary pairings of point sums indicated by point-sum indicia K in the point-sum zones B are shown, as well as indications of representative odds alternatives and the house take value for each of the indicated odds for the exemplary embodiment of a five-dice game. The representative odds alternatives depicted represent example odds settings that are lower than the break-even odds indicator from Chart 5, and the decimal number following each of the alternative odds settings represents a relative indicator of how much the house stands to gain over time (i.e., the house take value) for each wagering zone.

CHART 6

| Wager | | Odds | House Take |
|---|---|---|---|
| Zone | Point Sums | Alternatives | Values |
| C₁ | 13 or 22 | 6 to 1 | 24.386 |
| | | 7 to 1 | 13.584 |
| | | 8 to 1 | 2.782 |
| C₂ | 12 or 23 | 8 to 1 | 29.395 |
| | | 10 to 1 | 13.705 |
| C₃ | 11 or 24 | 12 to 1 | 31.451 |
| | | 15 to 1 | 15.632 |
| C₄ | 7 or 28 | 150 to 1 | 41.714 |
| | | 200 to 1 | 22.414 |
| | | 250 to 1 | 3.114 |
| C₅ | 6 or 29 | 500 to 1 | 35.371 |
| | | 600 to 1 | 22.471 |
| | | 750 to 1 | 3.121 |
| C₆ | 5 or 30 | 2,000 to 1 | 47.974 |
| | | 2,500 to 1 | 34.974 |
| | | 3,000 to 1 | 21.974 |
| | | 3,500 to 1 | 8.974 |
| C₇ | 8 or 27 | 75 to 1 | 31.60 |
| | | 100 to 1 | 9.10 |
| C₈ | 9 or 26 | 45 to 1 | 17.20 |
| | | 50 to 1 | 8.20 |
| C₉ | 10 or 25 | 25 to 1 | 15.734 |
| D₁ | 11, 12, 13, 22, 23, or 24 | 3 to 1 | 4.32 |
| D₂ | 5, 6, 7, 28, 29, or 30 | 120 to 1 | 34.66 |
| | | 150 to 1 | 18.46 |
| | | 175 to 1 | 4.96 |
| D₃ | 8, 9, 10, 25, 26, or 27 | 12 to 1 | 22.767 |
| | | 13 to 1 | 16.826 |
| | | 15 to 1 | 4.944 |
| E | 5, 6, 7, 8, 9, 10, 11, | 2 to 1 | 8.797 |
| | 12, 13, 22, 23, 24, 25, | | |
| | 26, 27, 28, 29, or 30 | | |
| F₁ | 14, 15, 16, or 17 | Even | 30.402 |
| | | 3 to 2 | 13.0025 |
| F₂ | 18, 19, 20, or 21 | Even | 30.402 |
| | | 3 to 2 | 13.0025 |
| S₁ | 5 of a kind | 750 to 1 | 42.173 |
| | | 1,000 to 1 | 22.923 |
| | | 1,200 to 1 | 7.523 |

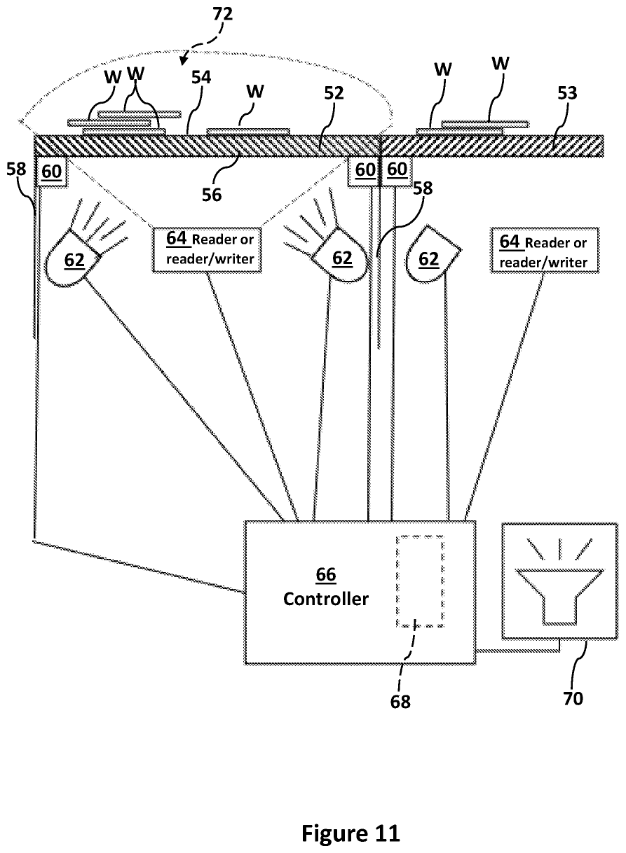

For example, the exemplary odds alternatives settings for primary wager zone C₁ are 6 to 1, 7 to 1, and 8 to 1 (each being lower than the break-even indicator for primary wager zone C₁ shown in FIG. 11 as 8.25754). For each of the potential odds settings 6 to 1, 7 to 1, and 8 to 1, the house take value is 24.386, 13.584, and 2.782, respectively. The house take value for the 6 to 1 odds setting is calculated as explained above with respect to the three-dice configuration. Again, the closer the house take value is to zero, the less value the house gains and the longer a player will remain in the game given a finite stake to begin without adding to the stake.

Similarly, the exemplary odds setting for tertiary wager zone E is 2 to 1 (being lower than the break-even indicator for tertiary wager zone E shown in FIG. 11 as 2.28937). For this particular potential odds setting, the house take value is 8.797. Also, the possible odds settings for first ancillary wager zone F₁ are “even odds” and 3 to 2 with a house take value of 30.402 and 13.0025, respectively. Additionally, for the configuration shown in FIG. 3, the exemplary odds settings for special ancillary wager zone S₁ may be 750 to 1, 1000 to 1, and 1200 to 1, for house take values of 42.173, 22.923, and 7.523, respectively.

For the sake of brevity and streamlining this disclosure, the calculation of the house take value for each potential odds setting will not be repeated for each wagering zone. The house take value for each potential odds setting may be calculated in the same fashion for each wagering zone. Moreover, if a different configuration is used, once the probability count is determined and the odds are set for a particular wager zone, the house take value for that wager zone can be calculated in the same fashion.

FIG. 4 is a plan view of an alternative game layout for another exemplary embodiment of a five-dice game showing a layout of wagering zones and point-sum zones B. The game layout A differs from the configuration of game layout A of FIG. 3 in that it has an additional point-sum zone B and represents an example of how point pairings may differ and how those differences affect the odds. The game layout A of FIG. 4 comprises a plurality of point-sum zones B, a plurality of primary wager zones C, a plurality of secondary wager zones D, a tertiary wager zone E, and a plurality of ancillary wager zones F. As depicted and by way of example, primary wager zone C₁ adjacently abuts point-sum zone B₁ and primary wager zone C₂ adjacently abuts point-sum zone B₂, but primary wager zone C₁ does not adjacently abut point-sum zone B₂. Adjacent abutment of a wagering zone with a particular point-sum zone B defines a wagering relationship identified by a relationship indicator G and means that the adjacently abutting wagering zone has a wagering relationship with the point-sum zone B it adjacently abuts, for example, primary wager zone C₁ has a wagering relationship with point-sum zone B₁ because it adjacently abuts point-sum zone B₁.

Similarly, secondary wager zone D₁ has a wagering relationship with point-sum zones B₁, B₂, and B₃ because secondary wager zone D₁ adjacently abuts point-sum zones B₁, B₂, and B₃. Also, secondary wager zone D₂ is slightly different in that it has a wagering relationship with point-sum zones B₄, B₅, B₆, and B₇ because secondary wager zone D₂ adjacently abuts point-sum zones B₄, B₅, B₆ and B₇. Further, tertiary wager zone E has a wagering relationship with secondary wager zones D₁, D₂, D₃ because tertiary wager zone E adjacently abuts secondary wager zones D₁, D₂, D₃. Tertiary wager zone E also has a wagering relationship with all of the point-sum zones B₁, B₂, B₃, B₄, B₅, B₆, B₇, B₈, B₉, B₁₀. These wagering relationships indicate which point sums apply to each of the wagering zones among the plurality of primary wager zones C, the plurality of secondary wager zones D, and the tertiary wager zone E.

In FIG. 4, exemplary pairings of point sums are indicated in ten point-sum zones B for this alternative exemplary embodiment of a five-dice game. Point sums 9 and 26 are depicted by point-sum indicia K in point-sum zone B₁; point sums 10 and 25 are depicted by point-sum indicia K in point-sum zone B₂; point sums 11 and 24 are depicted by point-sum indicia K in point-sum zone B₃; point sums 5 and 30 are depicted by point-sum indicia K in point-sum zone B₄, point sums 6 and 29 are depicted by point-sum indicia K in point-sum zone B₅; point sums 7 and 28 are depicted by point-sum indicia K in point-sum zone B₆; point sums 8 and 27 are depicted by point-sum indicia K in point-sum zone B₇; point sums 12 and 23 are depicted by point-sum indicia K in point-sum zone B₈; point sums 13 and 22 are depicted by point-sum indicia K in point-sum zone B₉; and point sums 14 and 21 are depicted by point-sum indicia K in point-sum zone B₁₀. As configured, a wager placed on primary wager zone C₁ is a wager that either point sum 9 or point sum 26 will be rolled, and a wager placed on primary wager zone C₂ is a wager that either point sum 10 or point sum 25 will be rolled. Wagers on primary wager zones C₃, C₄, C₅, C₆, C₇, C₈, C₉, and C₁₀ are handled in the same manner.

Additionally, as configured, a wager placed on secondary wager zone D₁ is a wager that any of point sums 9, 10, 11, 24, 25, or 26 will be rolled, and a wager placed on secondary wager zone D₂ is a wager that any of point sums 5, 6, 7, 8, 27, 28, 29, or 30 will be rolled. Accordingly, a wager placed on tertiary wager zone E is a wager that any of point sums 5, 6, 7, 8, 9, 10, 11, 12, 13, 14, 21, 22, 23, 24, 25, 26, 27, 28, 29, or 30 will be rolled. Of course, the alternative exemplary embodiment shown in FIG. 4 is only an example of one configuration of the game layout A. This alternative exemplary embodiment is being provided to demonstrate that if the point sum pairings, the arrangement of the point sum pairings, the geometric layout of the various zones, and the selections of which point sums are displayed in point-sum zones B differ from what is shown FIG. 3 then odds will change and that such changes will not depart from the spirit and scope of the invention. This alternative exemplary embodiment also demonstrates that the probabilities and odds shown in Charts 7 and 8, below, would differ from Charts 5 and 6. The probabilities and odds shown in Charts 5 and 6 are for the particular exemplary configuration shown in FIG. 3, while the probabilities and odds shown in Charts 7 and 8 are for the particular alternative configuration shown in FIG. 4.

CHART 7

| Wager | | Probability | Percent | Break-even |
|---|---|---|---|---|
| Zone | Point Sums | Count | Probability | Indicator |
| C₁ | 9 or 26 | 140 | 1.8% | 54.556 |
| C₂ | 10 or 25 | 252 | 3.241% | 29.85467 |
| C₃ | 11 to 24 | 410 | 5.273% | 17.96454 |
| C₄ | 5 or 30 | 2 | 0.026% | 3,845.15385 |
| C₅ | 6 or 29 | 10 | 0.129% | 774.1938 |
| C₆ | 7 or 28 | 30 | 0.386% | 258.06736 |
| C₇ | 8 or 27 | 70 | 0.9% | 110.11111 |
| C₈ | 12 or 23 | 610 | 7.845% | 11.74697 |
| C₉ | 13 or 22 | 840 | 10.802% | 8.25754 |
| C₁₀ | 14 or 21 | 1080 | 13.889% | 6.19994 |
| D₁ | 9, 10, 11, 24, 25, or | 802 | 10.314% | 8.69556 |
| | 26 | | | |
| D₂ | 5, 6, 7, 8, 27, 28, | 112 | 1.44% | 68.44444 |
| | 29, or 30 | | | |
| D₃ | 12, 13, 14, 21, 22, | 2530 | 32.536% | 2.392 |
| | or 23 | | | |
| E | 5, 6, 7, 8, 9, 10, 11, | 3444 | 44.29% | 1.25785 |
| | 12, 13, 14, 21, 22, | | | |
| | 23, 24, 25, 26, 27, | | | |
| | 28, 29, or 30 | | | |
| F₁ | 15, 16, or 17 | 2166 | 27.855% | 2.59002 |
| F₂ | 18, 19, or 20 | 2166 | 27.855% | 2.59002 |
| S₁ | 5 of a kind | 6 | 0.077% | 1297.7013 |

Turning now to the ancillary wager zones F of FIG. 4. Ancillary wager zones F are ancillary to the central portion of the game layout A and may comprise first ancillary wager zone F₁, second ancillary zone F₂, and special ancillary zone S₁. In the alternative configuration shown, first ancillary zone F₁ has only point sums 15, 16, and 17 depicted therein, and second ancillary zone F₂ has only point sums 18, 19, and 20 depicted therein. As a result, a wager placed on the first ancillary wager zone F₁ is a wager that any of point sums 15, 16, and 17 will be rolled, and a wager placed on second ancillary wager zone F₂ is a wager that any of point 18, 19, and 20 will be rolled. For this alternative exemplary embodiment, the point sums 14 and 21 have been moved into the central portion of the game layout A to encourage more wagering in the central portion of the game layout. Of course, the alternative exemplary embodiment shown in FIG. 4 is only an example of another configuration of the game layout A. The number of ancillary wager zones, the size and geometric layout of the ancillary zones, and the selections of which point sums are placed in ancillary wager zones could all differ from what is shown without departing from the spirit and scope of the invention. In such cases, the probabilities and odds shown in Charts 7 and 8 would differ accordingly. The probabilities and odds shown in Charts 7 and 8 are for the particular exemplary configuration shown in FIG. 4.

A single special ancillary wage zone S₁ is shown in FIG. 4 and is designated as a “5 of a kind” special outcome. Hence, a wager placed on special ancillary wager zone S₁ is a wager that all five dice will come up the same when rolled. In this special instance, point sum is not relevant to such a wager. Rather, the special circumstance must occur for there to be a payout on such a wager. Although only one special ancillary wager zone S₁ is shown, others are contemplated and may be used, such as a five dice straight (1-2-3-4-5 or 2-3-4-5-6), a full house (e.g., 1-1-1-3-3 or 2-2-2-6-6), or any other special circumstance. The number of special ancillary wager zones S₁, the size and geometric layout of the special ancillary wager zones S₁, and the selections of which special circumstances are indicated within the special ancillary wager zones S₁ may all differ from what is shown without departing from the spirit and scope of the invention. In such cases, the probabilities and odds shown in Charts 7 and 8 would differ accordingly.

In Chart 7, the integer depicted represents the probability count, the percentage depicted is the probability percentage, and the decimal number depicted is the break-even indicator for each wagering zone. For example, the probability count for primary wager zone C₁ is 140 and this means that averaging over time for every 7776 rolls of the dice, the point sum will be either 9 or 26 one hundred forty times. The probability count of 140 represents 1.8% of the rolls of the dice (i.e., 140 divided by 7776), and the decimal number 54.556 represents that if the odds were placed at 54.556 to 1, then the house would break even over time. The break-even indicator is calculated by subtracting the probability percentage from 100% (in this instance, 100%−1.8%=98.2%) and then dividing the result (98.2%) by the probability percentage (98.2% divided by 1.8%=54.556). The closer the odds are set to 54.556 to 1, the less value the house gains and the longer a player will survive playing the game given a finite stake to begin without adding to the stake.

Similarly, the probability count for tertiary wager zone E is 3,444, meaning that averaging over time for every 7776 rolls of the dice, the point sum will be 5, 6, 7, 8, 9, 10, 11, 12, 13, 14, 21, 22, 23, 24, 25, 26, 27, 28, 29, or 30 three thousand four hundred forty-four times, the probability percentage is 44.29% and the break-even indicator is 1.25785. Also, the probability count for first ancillary wager zone F₁ is 2166, meaning that averaging over time for every 7776 rolls of the dice, the point sum will be either 15, 16, or 17 two thousand one hundred sixty-six times, the probability percentage is 27.855% and the break-even indicator is 2.59002. Additionally, for the configuration shown in FIG. 4, the probability count for special ancillary wager zone S₁ is 6, meaning that averaging over time for every 7776 rolls of the dice, all five dice will be the same six times, the probability percentage is 0.077% and the break-even indicator is 1,297.7013.

For the sake of brevity and streamlining this disclosure, the determination and calculation of the probability count, the probability percentage, and the break-even indicator will not be repeated for each wagering zone. The probability percentage and the break-even indicator may be calculated in the same fashion for each wagering zone. Moreover, if a different configuration is used, once the probability count is determined for a particular wager zone, the probability percentage and the break-even indicator for that wager zone may be calculated in the same fashion.

Turning now to Chart 8, exemplary pairings of point sums indicated by point-sum indicia K in the point-sum zones B are shown as well as indications of representative odds alternatives and the house take value for each of the indicated odds for the alternative exemplary embodiment of a five-dice game. The representative odds alternatives depicted represent example odds settings that are lower than the break-even odds indicator from Chart 7, and the decimal number following each potential odds setting represents a relative indicator of how much the house stands to gain over time (i.e., the house take value) for each wagering zone.

CHART 8

| Wager | | Odds | House Take |
|---|---|---|---|
| Zone | Point Sums | Alternatives | Values |
| C₁ | 9 or 26 | 45 to 1 | 17.20 |
| | | 50 to 1 | 8.20 |
| C₂ | 10 or 25 | 25 to 1 | 15.734 |
| | | 28 to 1 | 6.011 |
| C₃ | 11 to 24 | 12 to 1 | 31.451 |
| | | 15 to 1 | 15.632 |
| | | 16 to 1 | 10.359 |
| C₄ | 5 or 30 | 2,000 to 1 | 47.974 |
| | | 2,500 to 1 | 34.974 |
| | | 3,000 to 1 | 21.974 |
| | | 3,500 to 1 | 8.974 |
| C₅ | 6 or 29 | 500 to 1 | 35.371 |
| | | 600 to 1 | 22.471 |
| | | 750 to 1 | 3.121 |
| C₆ | 7 or 28 | 150 to 1 | 41.714 |
| | | 200 to 1 | 22.414 |
| | | 250 to 1 | 3.114 |
| C₇ | 8 or 27 | 75 to 1 | 31.60 |
| | | 100 to 1 | 9.10 |
| C₈ | 12 or 23 | 8 to 1 | 29.395 |
| | | 10 to 1 | 13.705 |
| | | 11 to 1 | 5.860 |
| C₉ | 13 or 22 | 6 to 1 | 24.386 |
| | | 7 to 1 | 13.584 |
| | | 8 to 1 | 2.782 |
| C₁₀ | 14 or 21 | 5 to 1 | 16.666 |
| | | 6 to 1 | 2.777 |
| D₁ | 9, 10, 11, 24, 25, or 26 | 8 to 1 | 7.174 |
| D₂ | 5, 6, 7, 8, 27, 28, 29, or 30 | 65 to 1 | 4.96 |
| D₃ | 12, 13, 14, 21, 22, or 23 | 2 to 1 | 2.392 |
| E | 5, 6, 7, 8, 9, 10, 11, 12, 13, | Even | 11.42 |
| | 14, 21, 22, 23, 24, 25, 26, | | |
| | 27, 28, 29, or 30 | | |
| F₁ | 15, 16, or 17 | 2 to 1 | 16.435 |
| | | 5 to 2 | 2.5075 |
| F₂ | 18, 19, or 20 | 2 to 1 | 16.435 |
| | | 5 to 2 | 2.5075 |
| S₁ | 5 of a kind | 750 to 1 | 42.173 |
| | | 1,000 to 1 | 22.923 |
| | | 1,200 to 1 | 7.523 |

The exemplary alternative odds settings for primary wager zone C₁ are 45 to 1 and 50 to 1 (each being lower than the break-even indicator for primary wager zone C₁ shown in Chart 7 as 54.556). For each of the alternative odds settings 45 to 1 and 50 to 1, the house take value is 17.20 and 8.20, respectively. The house take value for the 45 to 1 odds setting is calculated as explained above with respect to the three-dice configuration. Again, the closer the house take value is to zero, the less value the house gains and the longer a player will survive playing the game given a finite stake to begin without adding to the stake.

Similarly, the alternative exemplary odds setting for tertiary wager zone E is “even odds” or 1 to 1 (being lower than the break-even indicator for tertiary wager zone E shown in Chart 8 as 1.25785). This odds setting results in the house take value of 11.42. Also, the alternative odds settings for first ancillary wager zone F₁ are 2 to 1 or 5 to 2 with a house take value of 16.435 and 2.5075, respectively. Additionally, for the configuration shown in FIG. 4, the alternative odds settings for special ancillary wager zone S₁ are 750 to 1, 1000 to 1, and 1200 to 1, for house take values of 42.173, 22.923, and 7.523, respectively.

For the sake of brevity and streamlining this disclosure, the calculation of the house take value for each potential odds setting will not be repeated for each wagering zone. The house take value for each potential odds setting may be calculated in the same fashion for each wagering zone. Moreover, if a different configuration is used, once the probability count is determined and the odds are set for a particular wager zone, the house take value for that wager zone can be calculated in the same fashion.

The game is generally played the same with each of the embodiments described herein. First, one or more players place wagers on whatever wagering zones they choose and in amount that they choose. Once all wagers are placed, the dice may be rolled (whether three, four, or five dice, depending on the embodiment being played). The sum of the dice rolled is determined and this sum is the point sum for that roll. For example, in a four-dice game, if 1-2-3-5 is rolled, the point sum is 11. Any wagers placed that pay for point sum 11 are paid out at the odds selected for each applicable wager zone. Wagers on any other wager zones are lost to the house. The game continues in this fashion.

As mentioned above, to create additional interest there are various alternative modes for play. By way of example only, there is a four-dice alternative for play on a five-dice layout. With this alternative, the player places his/her wager on a wager zone and declares either high or low. Then, the four dice are rolled. For illustration purposed, assume the roll of the four dice was 3-4-1-6. If the player declared high, then the highest dice is counted twice to arrive at the point sum. In this case, 3+4+1+6+6 for a point of 20. However, if the player declared low, then the lowest dice is counted twice to arrive at the point sum. In that case, 3+4+1+6+1 for a point sum of 15. The wagers are paid out as explained.

Yet another alternative way of playing would allow the player to select one dice to re-roll. In a five-dice game, where the initial roll of the dice was 4-2-5-5-5, the player might select the dice indicating “2” to be re-rolled. On the re-roll, if that dice came up “4”, the point sum would be 23 (4+4+5+5+5) and the wagers would be paid out accordingly.

Yet another alternative would be to have one preselected dice to be different (such as a different color or some other distinguishing characteristic). Similar to the high/low alternative, the preselected dice would be added twice to the sum. For example, if the roll was 6-3-1-6 and the preselected dice was the first 6, then the point sum would be 22 (6+3+1+6+6).

Still another variation would be to have the preselected dice be able to replace any dice. In a five-dice game if the roll were 2-5-3-1-3 and the preselected dice was the 2, the player might substitute the 2 for the 5 so that the point sum would become 11 (2+2+3+1+3).

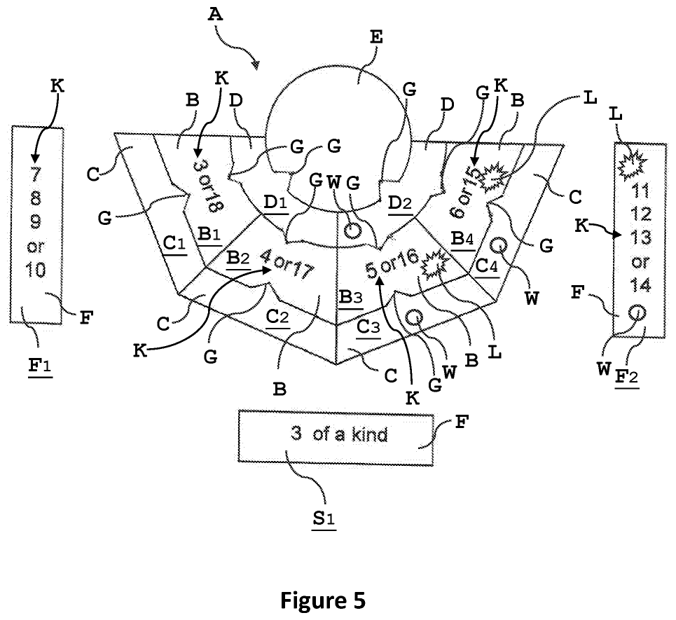

FIGS. 5-7 are representative embodiments of alternative exemplary game layouts A of a three-dice game similar to the embodiment illustrated in FIG. 1. It should be understood that FIGS. 5-7 are representative embodiments and the features disclosed with reference to FIGS. 5-7 may be applied readily to the embodiments depicted in FIGS. 2-4 and any other embodiments within the scope and spirit of this disclosure. In the interest of brevity, the features discussed below regarding FIGS. 5-7 will not be repeated for the embodiments depicted in FIGS. 2-4. Also, the descriptive disclosure given above regarding FIGS. 1-4 will not be repeated in detail to describe the embodiments of FIGS. 5-7.

Turning now to FIG. 5, a plan view of another exemplary embodiment of the game layout A is shown. This exemplary embodiment of the game layout A has an electronic aspect and uses a relationship indicator G augmenting adjacent abutment and illustrating pairings of point sums indicated in the point-sum zones B for a representative embodiment of a three-dice game. Additionally, FIG. 5 shows the game layout A staged after wager placement and before random point sum determination.

The game layout A in FIG. 5 differs from the game layout A in FIG. 1 in that alternative exemplary relationship indicators G are shown as augmented adjacent abutments having directional indicators that define the relationships between areas and zones. As representative examples, relationship indicators G indicate that secondary wager zone D₁ has a relationship with point-sum zones B₁ and B₂ and tertiary wager zone E, and primary wager zone C₃ has a relationship with point-sum zone B₃. The relationship indicators G define which point-sum zones B have a wagering relationship with which wager zones C, D, E.

As depicted, a representative wagering round prior to determining the point sum is depicted showing wager tokens W that have been placed on primary wager zones C₃ and C₄, secondary wager zone D₂, and second ancillary zone F₂. Because the point sum has not yet been determined, the point sums that are “in play” (i.e., the point sums that are potential winners) may be highlighted as designated by light bursts L. Hence, in this example, point-sum zones B₁ and B₂ and second ancillary zone F₂ are illuminated because the wagers placed have determined that point-sums 5, 6, 11, 12, 13, 14, 15, and 16 are in play.

For purposes of this disclosure, the term “highlight” and formatives thereof includes, but is not limited to, light-related illumination, as well as other forms of emphasizing in any manner such as causing the point-sum indicia K and/or odds indicia J to flash on and off or a change of intensity, brightness, size or color. Any change is visual presentation that draws attention to one or more (but not all) areas or zones within the game layout A are contemplated herein as being within the spirit and scope of the term “highlight” and all formatives thereof.

Such highlighting may be turned on manually by a dealer (“dealer” as used hereinafter includes the gaming house, a game administrator, a game operator or facilitator, or a software program acting as the dealer) or it may be turned on automatically based upon computer-controlled sensing of the placement of wager tokens W using any suitable type of sensor or token reader (not shown, but well known and some of which are discussed herein below) such as a load-bearing sensor that detects the weight of the wager tokens W, a magnetic sensor that detects the placement of the wager tokens W magnetically, an electronic sensor that detects the placement of the wager tokens W electronically, a token reader that identifies the presence of wager tokens W, or any other suitable sensor or reader. Also, some entertainment environments may use well-known touch-screen technology to move wager tokens W for placing a wager and correlating the wager to highlighting appropriate point-sum zones B and/or ancillary wager zones F.

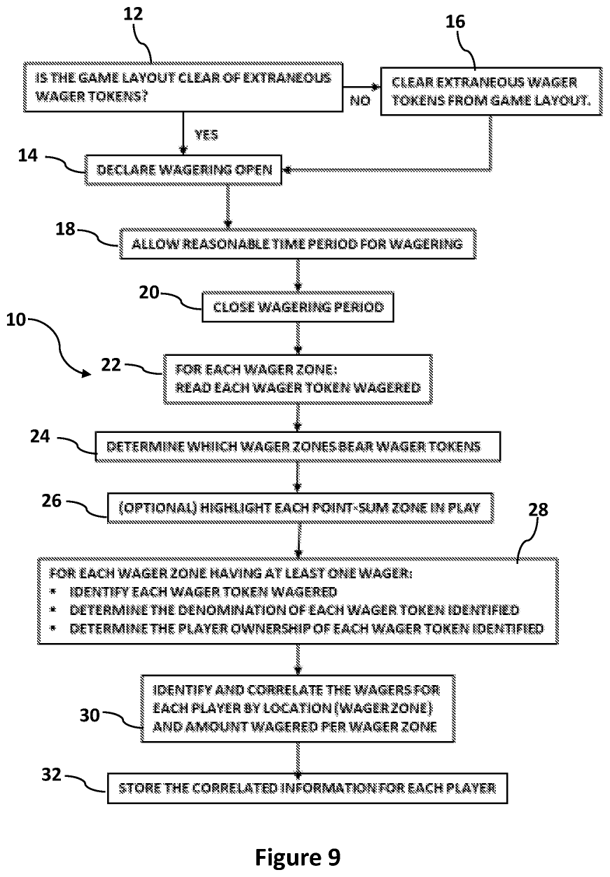

Once the wagering round is closed/completed (described herein below as the “Pre-Point-Sum Determination” portion of the game flow—see the discussion regarding FIG. 9) so that no further wagers are permitted, the point sum may be determined. The game may utilize one of many known types of multiple random number selectors to generate a point sum, which is the sum of each of the random number selectors. For example, if three random selectors are used and the numbers randomly selected were 1, 7, and 9, the point sum would be 17. Although any type of random number selector can be used, as mentioned above, for the purposes of this disclosure and for simplifying the explanation and streamlining the disclosure, the use of standard six-sided dice (a plurality of regular hexahedron selectors for the numbers 1 through 6 having six, equal square sides) has been selected as the random number selectors. However, it should be understood that other forms of random number selectors may be used without departing from the spirit of this invention. In fact, when the game layout has an electronic aspect, it may be advantageous to use an electronic random number generator to select random number combinations and have the point sum calculated electronically.

Once the point sum is determined, if the point sum is not one of the point sums that is “in play” the appropriate point-sum zone B or ancillary wager zone F may be highlighted to show which point sum would have paid out. No other zones or areas will be highlighted, so that the dealer may clear all wagers for the house. However, if the selected point sum was in play a different highlighting event may occur; for example, a highlight of steady intensity may change to a flashing highlight (e.g., on and off or changing in light intensity), an audible sound may be played, the highlight may change color, etc.

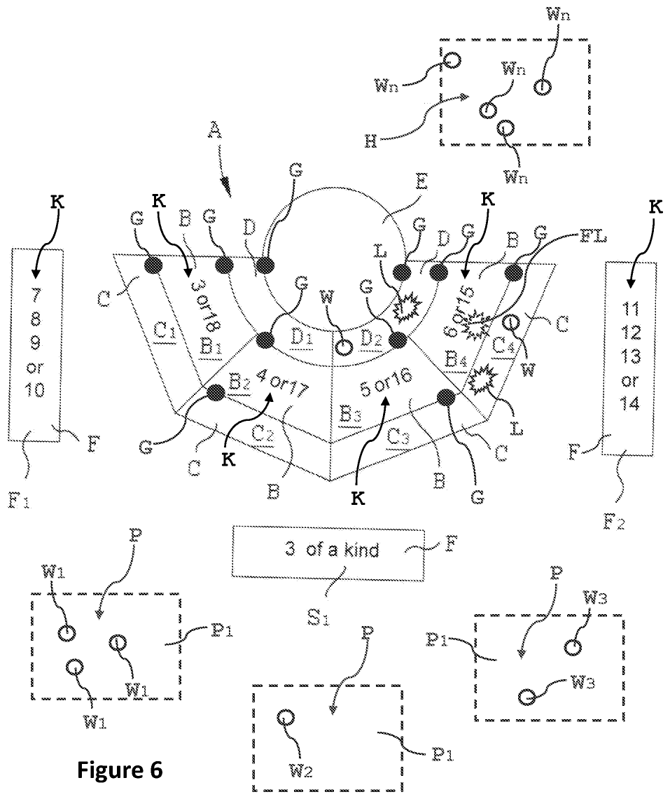

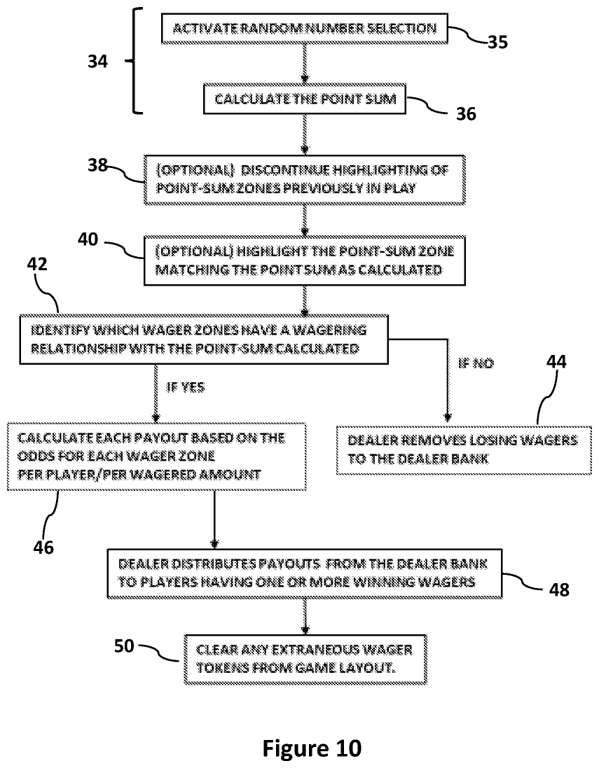

FIG. 6 depicts a situation where the selected point sum was in play. FIG. 6 shows yet another exemplary embodiment of a game layout A staged after the random point sum determination and the clearing of non-winning wagers, but before winning-wager payout (see FIG. 10 for flow chart depiction of the game flow of Point Sum Determination through Wagering Payout). Also, the game layout A in FIG. 6 differs from the game layout A in FIGS. 1 and 5 in that alternative relationship indicators G are shown as binding indicators that define the wagering relationships between areas and zones. As representative examples, relationship indicators G indicate that secondary wager zone D₁ has wagering relationships (bound) with point-sum zones B₁ and B₂ and tertiary wager zone E, and primary wager zone C₃ has a wagering relationship (bound) with point-sum zone B₃ The relationship indicators G define which point-sum zones B have a wagering relationship (bound) with which wager zones C, D, E.

The relationship indicators G depicted in FIG. 6; namely, solid, circular features that do not suggest any particular direction (thus, differing from the relationship indicators G depicted in FIG. 5) suggest a binding relationship between the areas and zones sharing a boundary at the location of each relationship indicator G. Although solid, circular features are shown in FIG. 6, it should be understood that other types of binding-suggestive features may be used that may or may not also have a directional aspect (such as a torx shape (a six-point star-shaped pattern), an oval (where the longitudinal axis coincides with the shared boundary), and a square with two opposite sides being parallel to the shared boundary are exemplars of binding non-directional features that may be used as relationship indicators G, among others) without departing from the spirit and scope of the present invention.

As depicted, the random point sum has been determined (calculated) and the non-winning wagers have been cleared, but the winning wagers are yet to be paid. For the purpose of this disclosure, it is assumed that FIG. 6 depicts a point sum of 15. Consequently, due to the location of the winning wagers, the point sum zone B₄ is highlighted as designated by flashing light burst FL (shown in phantom outline to signify flashing; for example, flashing off and on or flashing between different intensities) and the winning wagers are identified by highlighting primary wager zone C₄ and secondary wager zone D₂ as designated by light bursts L. Such flashing light burst FL and light bursts L will remain so highlighted until the winning wagers have been paid out and removed so that a new wagering round may ensue.

Also depicted in phantom lines in FIG. 6 are a dealer bank region H and player home regions P. The dealer bank region H generally represents an area where the dealer maintains a bank of wager tokens W for payouts, recirculation of lost wagers, making change, and exchanging wager tokens W for buy-ins to play the game. In many embodiments, the wager tokens W are merely tokens of various denominations (much like poker chips or casino chips). However, in some embodiments of the game disclosed herein, the wager tokens W may comprise player differentiation indicators and denomination indicators. Such player differentiation indicators may be permanent or changeable.

Where the player differentiation indicators are permanent, each player may use wager tokens W that have permanent, visual indicia identifying a specific player. Such indicia may be, by way of example and not limited to, an alphanumeric designation, a symbol, a design feature, a color or color combination, or any other differentiating feature. For example, wager tokens W for player 1 (designated by W₁ in FIGS. 6 and 7) may differ in design or color from wager tokens W for player 2 (designated by W₂) and both player wager tokens W₁ and W₂ may differ in design or color from wager tokens W for player 3 (designated by W₃). When permanent, visual indicia is used to identify wager tokens W of a particular player, the dealer will need to maintain separate banks for each player so that winning wagers may be paid with corresponding player wager tokens and losing wagers may be collected and stored in a bank devoted to the particular player. To facilitate the retrieval of losing bets from all players, it may be advantageous to have a sorting machine that receives the losing bets in bulk and separates them out into respective player wager tokens to be stored in separate banks for the various players.

In some embodiments, the wager tokens W may have changeable characteristics. One or more characteristic changing devices (not shown, but known in the art will be described herein below) may be used to change one or more characteristics into a different characteristic. By way of example using known technical capabilities, either magnetically or electronically, the nature of certain aspects of the wager tokens may be changeable to facilitate the playing of the game, in a manner much like plastic card hotel keys, identity and access tokens or cards, proximity cards using Passive RFID (radio-frequency identification), reprogrammable vicinity cards, near-field communication (NFC) smart cards with contactless rewriteable microchips, may be changeable.

With hotel plastic card hotel keys, certain information is encoded within the key (either magnetically or electronically), and that information may be read to provide the access code to open a particular hotel room door and/or identify the card holder to have certain hotel privileges (such as to a private lounge, the pool area, and/or the on-site or an off-site fitness center). Because hotel cards do not transmit information typically, the information encoded onto the card is read by a reader in the lock being accessed. The ownership of the card is not kept on the card usually, but is stored in a memory remote from the card. As the card may travel in the hotel guest's possession among various destinations (such as to the guest's assigned room, a private lounge, the pool area, and/or the on-site or an off-site fitness center), the reader at each location reads the card, thereby identifying where the card is located when being read. The location of each reading of the card may be logged and stored or re-rewritten and stored in the memory remote from the card. Although the information on the card does not change necessarily, the information stored remotely from the card does change. Technology used for hotel cards could be used in wager tokens W. However, rather than changing information on the wager token W, the tracking of each reading of the wager token W as it is moved about the game layout A can serve to track ownership of the wager token W by referring to the remotely stored data identifying the recent locations where the wager token W was read. For example, a wager token W parked in the dealer bank region H is ownership neutral and can be identified as Wₙ. As the wager token Wₙ is sold to a player (e.g., a player occupying the first position) and that player moves the wager token Wₙ into his/her player home region P₁, that wager token Wₙ is read and the location is logged or rewritten into the remote memory so that the wager token is now identified as W₁. If player P₁ then wagers that wager token W₁ and loses the bet, the wager token W₁ is taken back into the dealer bank region H where it is read and logged or rewritten to ownership neutral and identified as Wₙ. Then, if the wager token Wₙ to the player occupying the third position, player P₃, and that player P₃ moves the wager token Wₙ into his/her player home region P₃, that wager token Wₙ is read and the location is logged or rewritten into the remote memory so that the wager token is now identified as W₃. And, the process continues in that fashion throughout the game playing. Hence, for purposes of this disclosure, the logging or rewriting of information correlating reader locations to ownership of the wager tokens W shall be deemed to be changeable player/neutral differentiation characteristics.

Similarly, identity and access tokens or cards may be read or transmit information to identify the person having access authorization and may deny access to that same person (or holder of the card) until an intervening exit has been established (recording or reading and storing the exit event may involve changing information on the identity and access token or card. The technology of identity and access tokens or cards operates similar to hotel card technology; therefore, for purposes of this disclosure, the logging or rewriting of information correlating reader locations to ownership of the wager tokens W shall be deemed to be changeable player/neutral differentiation characteristics.

With the technology used in proximity cards using Passive RFID (radio-frequency identification) the identification of the wager token is read and the location of the wager token may be determined from knowing which reader is accessing the information encoded into the wager token W. Ownership of wager tokens W is not encoded into the wager token but is tracked, rewritten and stored in a memory remote from the wager token each time the wager token is moved about the game layout A among wager zones, the dealer bank region H, and player home regions P.

Reprogrammable vicinity cards offer technology that is slightly different from the technologies discussed above. Such cards have a reprogrammable chip embedded therein, and that chip may be read by a reader and reprogrammed by a writer when within the vicinity range of the reader and the writer, respectively. Combined reader/writer units do exist for such vicinity cards, and they have vicinity range capability up to about two meters, but can be set to much closer range. Using this type of technology, a similar reprogrammable chip may be embedded within or attached to each wager token W. This reprogrammable chip may be rewritten to identify the player/neutral differentiation characteristic attributable to the ownership of the wager token W; for example, wager tokens Wₙ for wager tokens W most recently possessed in the dealer bank region H and W₁, W₂, W₃, and so on for wager tokens W most recently possessed in player home regions P₁, P₂, P₃, and so on, respectively. With this exemplary embodiment of wager tokens W, each wager token W has changeable player/neutral differentiation characteristics encoded within or on each wager token W.

The technology used for near-field communication (NFC) smart cards with contactless rewriteable microchips is commonly used for contactless payments by credit, debit, and prepaid cards. This technology is particularly suitable for providing changeable player/neutral differentiation characteristics encoded within or on each wager token W. It has reading and rewriting capability that is contactless and has sufficient, but limited range so that the range is not likely to bleed into adjacent wager zones. With this exemplary embodiment of wager tokens W, each wager token W has a contactless rewriteable microchip embedded into or attached thereto so that changeable player/neutral differentiation characteristics may be encoded and rewritten within or on each wager token W.

The discussion above is representative of some representative, well-known technologies that are contemplated by this disclosure and may be implemented into the tracking, recording, and/or rewriting of the changeable ownership characteristic of wager tokens W. It should be understood that other technologies now existing or that may be developed in the future may be implemented to provide and/or attribute the changeable ownership characteristic to wager tokens W, and such other technologies are contemplated to be within the spirit and scope of this disclosure. Armed with this disclosure, those skilled in the art of one or more of these technologies could implement such to provide or attribute the changeable ownership characteristic to wager tokens W without undue experimentation.

In the exemplary embodiments disclosed herein, the wager tokens W may have unchanging specific token identification (each wager token may bear an unchangeable identification code to distinguish it from all other wager tokens), encoded unchanging denomination values for each wager token, and/or color-coded visual-differentiation of denominations (e.g., blue for $1, red for $5, green for $25, black for $100, silver for $500, gold for $1,000, etc.) and changeable player/neutral differentiation characteristics that tracks, records, and/or rewrites ownership of the wager tokens W.

Each wager token W that is stored in or drawn into the dealer bank region H is automatically tracked, recorded, encoded and/or rewritten as a neutral wager token Wₙ and remains so encoded until it is changed. Each neutral wager token Wₙ remains a neutral wager token Wₙ until it is stored in or drawn into one of the player home regions P and converted into a player wager token W₁, W₂, W₃, etc. depending on if it is drawn into or stored in player 1 home region P₁, player 2 home region P₂, player 3 home region P₃, etc., respectively.

As the wager tokens W travel during the playing of the game, such wager tokens W may change their player/neutral differentiation characteristics many times. Wager tokens W paid out by the dealer from the dealer bank region H remain neutral wager tokens Wₙ until they are drawn into the purchasing or winning player's player home region P and changed into a wager token W₁, W₂, W₃, etc. depending on whether the purchasing or winning player is player 1, player 2, player 3, etc. Similarly, the wager tokens W remain player wager tokens W₁, W₂, W₃, etc. while stored in the respective player home regions P (i.e., P₁, P₂, P₃, etc.) or placed on the game layout A. Player wager tokens W₁, W₂, W₃, etc. placed on the actual game layout A as opposed to the dealer bank region H remain unchanged from the specific player encoded. Losing wagers are cleared from the game layout A and are drawn into the dealer bank region H to be converted into neutral wager tokens Wₙ.

By differentiating between players and having differentiating characteristics for the wager tokens W, the “ownership” of a stray token can be determined by placing the stray wager token Win communication with a token reader. Also, if a dispute arises about whether a particular wager was made by one wagering player or another, the wagered token W can be placed in communication with the token reader to resolve the dispute.

A representative example of the changing of player/neutral characteristics, may be as follows: Leg 1) Player 1 purchases his stake of wager tokens W to buy into the game, and the dealer gives Player 1 neutral wager tokens Wₙ from the dealer bank region H; Leg 2) Player 1 draws the Wₙ tokens purchased into player 1 home region P₁ for storage and all such neutral wager tokens Wₙ convert into player 1 wager tokens W₁ automatically; Leg 3) Player 1 wagers one of his wager tokens W₁ on the game layout, and the wager token W₁ remains unchanged; Leg 4) Player 1 wins his wager and draws the wager token W₁, along with his winnings of neutral wager tokens Wₙ into his player 1 home region P₁, and the wager token W₁ remains unchanged while all of the neutral wager tokens Wₙ are converted into player 1 wager tokens W₁; Leg 5) Player 1 again wagers his wager token W₁ on the game layout, and the wager token W₁ remains unchanged; Leg 6) Player 1 loses his wager and the dealer draws the losing player wager token W₁ into the dealer bank region H to be converted into a neutral wager token Wₙ; Leg 7) Dealer pays out the now neutral wager token Wₙ to player 3 for winning his wager, and the neutral wager token Wₙ is converted in to a player 3 wager token W₃ when it is drawn into the player 3 home region P₃; and so forth to Leg 8 and beyond as the game progresses.

Because the wager tokens W that are stored in the dealer bank region H are all neutral wager tokens Wₙ and can be sensed or read, the denomination of each neutral wager token Wₙ also may be sensed or read such that they may be tallied and totaled so that a read out or display may indicate how many tokens of each denomination are stored within the dealer bank region H and a total value may also be communicated, audibly or visibly, to the dealer in virtual real time.

Similarly, for each player home region P, any wager tokens W located within each player home region P will have been converted to a player-specific player wager token W₁, W₂, W₃, etc. Again, each of the player wager tokens W₁, W₂, W₃, etc. can be sensed and the denomination of each player wager tokens W₁, W₂, W₃, etc. also may be sensed such that they may be tallied and totaled so that a read out or display may communicate to each individual player how many tokens of each denomination are stored within each player's player home region P₁, P₂, P₃, respectively. The communication by read out or display may be of any suitable type such as on the gaming table, on a handheld device at or near the gaming table, or may be conveyed to a player's smart phone to be shown on an app that may connect to the gaming table.

Further, in some embodiments, each wagering zone may have token reader or token reader/writer capability. Because each wagered token W will be a player wager token W₁, W₂, W₃, etc., each wagered token W could be read to determine 1) which wagering player placed the wager, 2) the wagering zone where the location of the wager was made, and 3) the denomination of the wager token W. Armed with this information from the reader or reader/writer and knowing the odds for each wagering zone, the specific payout for each winning wager may be calculated and communicated to the dealer. Such capability, would significantly streamline and facilitate the payout process so that the game will proceed more efficiently. More wagering rounds per unit of time may be played.

FIG. 7 depicts another situation where the selected point sum was in play. FIG. 7 shows yet another exemplary embodiment of a game layout A staged after the random point sum determination and the clearing of non-winning wagers, but before winning-wager payout. Also, the game layout A in FIG. 7 differs from the game layout A in FIGS. 1, 5, and 6 in that another exemplary set of relationship indicators G are shown as combination direction/binding indicators that define the wagering relationships between areas and zones. As representative examples, relationship indicators G indicate that secondary wager zone D₁ has a wagering relationship (directional and bound) with point-sum zones B₁ and B₂ and tertiary wager zone E, and primary wager zone C₃ has a wagering relationship (directional and bound) with point-sum zone B₃. The relationship indicators G define which point-sum zones B have wagering relationships (directional and bound) with which wager zones C, D, E.

As depicted, the random point sum has been determined and the non-winning wagers have been cleared, but the winning wagers are yet to be paid. For the purpose of this disclosure, it is assumed that FIG. 7 depicts a point sum of 12. Consequently, due to the location of the winning wager, the second ancillary zone F₂ is highlighted as designated by light burst L. This light burst L will remain highlighted until the winning wager has been paid out and removed so that a new wagering round may ensue.

Of course, with the variations on the game that have been disclosed herein, the odds as reflected by odds indicia J (see FIG. 8) in the various wager zones may be selected accordingly.

The flow chart depiction of FIG. 9 shows various steps (some optional) relating to an exemplary embodiment of the Pre-Point Sum Determination portion 10 of the game flow. The Pre-Point Sum Determination portion 10 of the game flow extends from game layout A readiness through completion of the wagering process. The first step is a game readiness query 12 that determines if the game layout A is ready for play. If yes, the next step is to open wagering 14. If no, the next step is to make the game layout A ready for play 16, and after completed, then the open wagering 14 step may be declared. Such declaration to open wagering 14, may be audible from the dealer or from a recording and/or visible from a display that announces that wagering is open. Thereafter, the step to allow a period for wagering 18 ensues. The length of the wagering period 18 may be a set amount of time or it may be determined by a dealer who assesses the period needed to reasonably make wagers based on the established flow of the game (e.g., a dealer may assess that more time is needed if there are six players than if there are only two players, or if the dealer determines that one player legitimately needs more time to wager for any justifiable reason). The close wagering period 20 step may be declared or announced in a manner similar to the opening of the wagering period.

Once the wagering is closed, each wager zone may be surveyed to determine if there are any wager tokens W that have placed thereon or if there are any ambiguous wager placements (such as ones that are improperly placed in a point-sum zone or straddle a line, because unlike with some other wagering games, no straddle bets are allowed).

With game layouts having an electronic aspect to them, each wager token W placed within each wager zone may be read (see FIG. 11 for a representative example of how such reading occurs) as part of the read wagered tokens 22 step. By reading each wager token W wagered, the wagering zones bearing wagers of wager tokens W may be identified as the active wagering zones determination 24 step. Optionally, the point-sum in play highlighting 26 step may be implemented to highlight the point-sum zones B that have wagering relationships with at least one wagering zone identified has having wagers thereon, thereby identifying for the players which point-sums are in play.

Depending on the technology used (see the various representative technologies discussed above), each player home region P, the dealer bank region H, and each wagering zone will have at least one reader or reader/writer with reading field 72 capability (see FIG. 11 for a representative example of a reading field 72) that will read encoded information embedded in or disposed on each wagered wager token W. Such encoded information may comprise a token identification code that is permanent and unique to each wager token W and identifies each specific token, a denomination code that is permanent and identifies the value assigned to each wager token W, and for wager tokens used with reader/writers a changeable (rewritable) player/neutral differentiation code that identifies ownership of the wager token W at any particular time during the game whether it be wager tokens W1, W2, W3, etc. owned by players P1, P2, P3, etc., respectively, or neutral house-owned wager tokens Wn. For technologies not having the reader/writer capability, the changeable nature of ownership may be tracked, recorded, logged and/or stored in a memory remote from the wager tokens W by reading the permanent and unique token identification code and knowing which reader conducts the reading of the wager token(s) W. The reading of each wager token W wagered comprises the data gathering 28 step of 1) identifying each wager token W wagered by reading the permanent and unique token identification code, 2) determining the denomination of each identified wager token W wagered, 3) determine the player ownership of each wager token W wagered. Armed with this gathered data, the identify and correlate wagers 30 step may be performed by a software program and temporarily stored by each wager for each player as the store per player 32 step.

To assure that every wager is read, a master wager token list may be maintained that contains the unique token identification code for each wager token W being used at the game layout A table whether it is being stored within the dealer bank region H, within any of the player home regions P, or has be wagered at a wagering zone. Just after each stage of play that involves movement of wager tokens W, once such movement has ceased, all of the wager tokens W in play may be read and checked against the master token list to make certain each wager token has been accounted for. This feature also may serve as a quality check against the reader(s) or reader/writer(s) assurance that all wager tokens W within a particular wagering zone have been read. Stacked wager tokens W may present challenges to reading all of the wagered wager tokens W. However, because each wager token has a permanent and unique token identification code, if each wager token W is read one at a time, the reader may be programmed to search for another wager token W (one that has not already read) after the reading of each wager token W. In this manner, the reader or reader/writer will continue searching until all wager tokens W have been accounted for as compared against the master wager token list.

Also, there are several other possible checks that may be utilized to assure that every wager is read. One exemplary check may be load sensors positioned to determine weight upon each wagering zone, and because the weight of wager tokens W is known, such weight is a function of how many wager tokens are wagered on the wagering zone. As a result, for example, if the weight read from the load sensor(s) suggests that five tokens have been wagered but only four have been read, the dealer may receive an alert telling that a particular wagering zone has not completed reading all wager tokens W. The dealer may remedy the problem by merely reshuffling or reducing the height of any stacks of tokens or just repositioning some tokens without disturbing the separateness of the wagers. Similarly, a scanning camera may be trained upon each wagering zone to determine the number of wager tokens wagered, and if the number determined by the scanning camera does not match the number of tokens read a similar alert to the dealer may be sent so that the dealer can remedy the incomplete reading in that same manner as suggested above.

By going through the steps described above, the progress of the game is now ready for the point sum to be determined.

FIG. 10 is a flow chart continuation of the flow chart of FIG. 9 depicting follow-on exemplary steps from Point Sum Determination 34 through Wagering Payout (the payout distribution 48 step) and next wagering round readiness (namely, the clearing extraneous wager tokens 50 step). An activating random number selection 35 step may take on one of many forms. For example, a player P may shake and roll dice if dice are used as the random number selectors, a dealer or player P may turn a cage if caged dice are used, a dealer or play P may push a button or pull a lever to start rotating cylinders moving much like random selectors used for some slot machines. In short, any type of known random selector may be used and activated to generate numbers to be added together to arrive at a resulting point sum. Consequently, once the random numbers have been selected, the calculate point sum 36 step may be performed by adding the randomly selected number together to arrive at the point sum. Once calculated, the point sum may be audibly announced by the dealer or as a prerecorded announcement.

Optionally, to facilitate the visual aesthetics and the information delivery to players P and observing potential players, discontinuing the highlighting of previously-highlighted point-sum zones B that do not match the point-sum determined (referred to as the de-highlighting non-winning point-sum zones 38 step) conveys that wagers placed on wagering zones having wagering relationships with such non-matching point sums are non-winners and highlighting the point-sum zone matching the point-sum determined (referred to highlighting the winning point-sum zone 40 step). Such highlighting of the winning point-sum zone 40, may be the same type of highlighting as done in the point-sum in play highlighting 26 step, or the type of highlighting may differ by, for example, flashing on and off or changing intensities, changing color, or any other differing highlighting.

Although it is optional, such highlighting helps identify which wagering zones have a wagering relationship with the winning point sum (referred to as identifying winning wagering zones 42 step). Additionally, once the point sum is determined, that data may be entered into previously-mentioned software program by any suitable means, such as by way of example entering it into a keypad, having the random number selector transmit the selection results electronically to the software program directly, or by pressing a button corresponding to the point sum on an array of buttons each corresponding to a possible point sum. The dealer clears all non-winning wagering zones (referred to as the clearing non-winning wagering zones 44 step). The dealer or the aforementioned software program or any other suitable known method calculates or determines (dealers frequently just match wager stacks in accordance with the odds indicia (for example, with winning at 3 to 1 odds, a dealer may just match the wager stack with three identical stacks) the payout for each player per wagered amount augmented by the odds applicable to the wagered amount (referred to as the payout calculation 46 step). During the payout distribution 48 step, the dealer distributes payouts from the dealer bank region H to each winning player P having one or more winning wagers. Each winning player P then draws all winnings (and the wager(s)) into each player's respective player home region P, thereby clearing all wager tokens W from the game layout A. If any extraneous wager tokens W remain on the game layout A, the dealer may clear them (the clearing extraneous wager tokens 50 step) so that play can proceed to another wagering round.

FIG. 11 is a schematic depiction of an elevational section of a portion of an exemplary game layout A having various representative electronic aspects provided by various representative components. Depicted in FIG. 11 is a sectioned portion of the game layout A viewed from a perspective that shows wagering zone table portions 52 and 53, respectively, having an upper-side surface 54 and an underside surface 56, partitioning barriers 58, specialty sensors 60, light-emitting elements 62, data gathering element 64 (either a reader or a reader/writer) having reading field 72, a controller 66 having a memory storage 68, and a audio element 70. Each of the wagering zone table portions 52 and 53 is made of a material such as glass, Plexiglass, Lucite, or any other suitable polymer or non-polymer that is at least translucent to light. The partitioning barriers 58 are disposed at lease between wagering zones and made of a material that shields against bleed between wagering zones of whatever type of frequency is used by the technology selected for reading and/or rewriting of wager tokens W. The specialty sensors 60 may be load sensors, scanning camera sensors, or any other type of sensor that provides data used to determine the number of wager tokens W placed within a wagering zone.

The light-emitting elements 62 may be directed to the underside surface 56 of each wagering zone table portion 52, 53 and may be of any suitable type such as LEDs, incandescent, florescent, neon, and the like, and may be color changing capability, may have flashing capability (on and off or alternating intensities), or may have any other highlighting capability. As depicted in FIG. 11, the light-emitting elements 62 of wagering zone table portion 52 are turned on in response to a signal received from the controller 66 based on data gathered and processes to establish that the light-emitting elements 62 should be turned on. In contrast, the light-emitting element 62 of wagering zone table portion 52 remain turned off because no signal received from the controller 66 has been sent to turn on the light-emitting element 62.

Each data gathering element 64 (whether a reader or a reader/writer) is designed to read and/or rewrite data encoded within or on the wager tokens W resting upon the upper-side surface 54 of table portions 52, 53 used in the exemplary embodiments of games of this disclosure having an electronic aspect. Such data gathering elements 64 convey the data gathered from the wager tokens W within the reading field 72 (designated by phantom lines and as explained above), along with the identification/location data applicable to each respective data gathering element 64 to the controller 66 that operates the software program (mentioned above) to make calculations, to organize and correlate data gathered so that it is usable to facilitate the playing of the game, and to store information in the memory storage 68 for retrieval and use to facilitate the determinations, identifications, and all other aspects of the game as described herein.

The controller 66 also operates the light-emitting elements 62, receives and processes data from the specialty sensors 60, and operates the audio element 70. The audio element 70 may sound an alarm, an alert, prerecorded dialogue or statements (see the descriptions relating to the declaration to open wagering 14, the close wagering period 20 step, the point sum may be audibly announced, an alert telling that a particular wagering zone has not completed reading all wager tokens W, or any other sound that may facilitate or raise excitement in the game.

Although the exemplary embodiments of a game of change having an electronic aspect described above involves a physical table and players interacting with the game layout A of that table, it should be understood, of course, that armed with the disclosures set forth herein those skilled in the art could easily transform the exemplary games of chance onto a smart phone or tablet or ipad app platform, a web-based application platform, a computer based platform, and/or a gaming platform such as Xbox, Nintendo, Switch, Play Station or any other such system. Consequently, the games of chance as transformed into such platforms fall with the spirit and scope of this invention and the claims stated herein should be reasonably interpreted to include such platforms provided the platform equivalent of each element is present.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, Chart, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles of the invention.

While specific exemplary embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A game of chance for one or more wagering players comprising:
at least three random number selectors for determining a point sum by adding together the randomly selected numbers; and
a game layout comprising:
a plurality of point-sum zones; each point-sum zone indicating at least one point-sum indicia associated with that point-sum zone;
a plurality of wagering zones comprising:
a plurality of primary wager zones; each primary wager zone having a wagering relationship with one of the plurality of point-sum zones and the point-sum indicia associated with such point-sum zone;
a plurality of secondary wager zones; and
at least one tertiary wager zone;
at least one relationship indicator for indicating the wagering relationships between point-sum zones and wagering zones, each primary wager zone having one of the relationship indicators that indicates the wagering relationship with one of the point-sum zones and the point-sum indicia associated with such point-sum zone, each secondary wager zone having more than one of the relationship indicators that indicates the wagering relationship with more than one of the point-sum zones and the point-sum indicia associated with each such point-sum zone, the tertiary wager zone more than one of the relationship indicators that indicates the wagering relationship with more than one of the secondary wager zones, the point-sum zones having the wagering relationship with each of the more than one secondary wager zones, and the point-sum indicia associated with each such point-sum zone; and
wherein each of the plurality of wagering zones have predetermined odds indicia, and wherein the wagering player is paid according to the odds indicia when the point sum matches the point-sum indicia having the wagering relationship with at least one of the wagering zones.

2. The game of chance as in claim 1 wherein the game layout further comprises at least one ancillary wager zone, each ancillary wager zone has point-sum indicia and odds indicia, and wherein the wagering player is paid according to the odds indicia when the point sum matches the point-sum indicia associated with at least one of the ancillary wager zones.

3. The game of chance as in claim 1 wherein the game layout further comprises at least one ancillary wager zone and the at least one ancillary wager zone is a special wager zone, the special wager zone has a circumstance indicia and odds indicia, and the wagering player is paid according to the odds indicia when the randomly selected numbers match the circumstance indicia associated with the special ancillary wager zone.

4. The game of chance as in claim 1 wherein one or more of the point-sum zones are highlighted after the wagering player places a wager at one or more wagering zones having the wagering relationship with the one or more point-sum zones, the point-sum zones highlighted correspond to which point sums are in play prior to determining the point sum.

5. The game of chance as in claim 1 wherein, after the point sum is determined, one or more of the wagering zones is highlighted corresponding to which of the wagering zones have the wagering relationship matching the point sum determined, the point-sum zone matching the determined point sum is highlighted to identify the determined point sum.

6. The game of chance as in claim 5 wherein the point-sum zone matching the determined point sum is highlighted with a flashing highlight.

7. The game of chance as in claim 1 further comprising wager tokens, the wagering player paces a wager by placing a wager token within a wagering zone.

8. The game of chance as in claim 7 wherein the wager tokens comprise a permanent denomination characteristic and a permanent and uniquely different token identification code for each wager token.

9. The game of chance as in claim 7 wherein the wager tokens are identifiably changeable between a player differentiation code and a neutral code to identify the ownership of each wager token at any given time during play of the game of chance.

10. The game of chance as in claim 9 further comprising a dealer bank region for storing wager tokens for which a dealer has access and a data gathering element operating within the dealer bank region, the data gathering element provides data to a controller that assigns a neutral ownership characteristic to wager tokens placed within the dealer bank region and such neutral ownership characteristic remains unchanged until any such wager token is placed within a player home region.

11. The game of chance as in claim 9 further comprising at least one player home region for storing wager tokens for which one of the wagering players has access and a data gathering element operating within the at least one player home region, the data gathering element provides data to a controller that assigns a player ownership characteristic to wager tokens corresponding to the player home region into which such wager tokens are placed and such player ownership characteristic remains unchanged until any such wager token is placed within the dealer bank region or a different player home region.

12. The game of chance as in claim 10 further comprising a sensor that detects the wager tokens within the dealer bank region and determines the denomination characteristic of each such wager token for tallying and calculating the total value of the wager tokens within the dealer bank region, the total value being communicated to the dealer.

13. The game of chance as in claim 11 further comprising a sensor that detects the wager tokens within the at least one player home region and determines the denomination characteristic of each such wager token for tallying and calculating the total value of the wager tokens within the at least one player home region, the total value being communicated to the wagering player having access to the at least one player home region.

14. The game of chance as in claim 1 wherein the at least one relationship indicator is selected from the group of indicators consisting of adjacent abutment, directional indicator, binding indicator, and combinations thereof.

15. A game of chance for one or more wagering players comprising:
at least three random number selectors for determining a point sum by adding together the randomly selected numbers; and
a game layout comprising:
a plurality of point-sum zones; each point-sum zone having the capability of being highlighted and having at least one point-sum indicia associated with that point-sum zone;
a plurality of wagering zones, each wagering zone having the capability of being highlighted, the plurality of wagering zones comprising:
a plurality of primary wager zones; each primary wager zone having a wagering relationship with one of the plurality of point-sum zones and the point-sum indicia associated with such point-sum zone;
a plurality of secondary wager zones; and
at least one tertiary wager zone;
at least one relationship indicator for indicating the wagering relationships between point-sum zones and wagering zones, each primary wager zone having one of the relationship indicators that indicates the wagering relationship with one of the point-sum zones and the point-sum indicia associated with such point-sum zone, each secondary wager zone having more than one of the relationship indicators that indicates the wagering relationships with more than one of the point-sum zones and the point-sum indicia associated with each such point-sum zone, the tertiary wager zone having more than one of the relationship indicators that indicates the wagering relationships with more than one of the secondary wager zones, the point-sum zones having the wagering relationship with each of the more than one secondary wager zones, and the point-sum indicia associated with each such point-sum zone;
a plurality of wager tokens, the wagering player places a wager by placing at least one wager token within at least one wagering zone; and
wherein each of the plurality of wagering zones have predetermined odds indicia, and wherein the wagering player is paid according to the odds indicia when the point sum matches the point-sum indicia having the wagering relationship with at least one of the wagering zones wherein a wagering player has placed a wager.

16. A game of chance as in claim 15 wherein the game layout further comprises at least one ancillary wager zone, each ancillary wager zone has point-sum indicia and odds indicia and has the capability of being highlighted, and wherein the wagering player is paid according to the odds indicia when the point sum matches the point-sum indicia associated with at least one of the ancillary wager zones.

17. A game of chance as in claim 15 wherein the game layout further comprises at least one ancillary wager zone, each ancillary wager zone has the capability of being highlighted, the at least one ancillary wager zone comprises a special wager zone, the special wager zone has a circumstance indicia and odds indicia, and the wagering player is paid according to the odds indicia when the randomly selected numbers match the circumstance indicia associated with the special ancillary wager zone.

18. A game of chance as in claim 15 wherein one or more point-sum zones has the capability of being highlighted after the wagering player places a wager at one or more wagering zones, one or more point-sum zones are highlighted to indicate which point sums are in play prior to determining the point sum.

19. A game of chance as in claim 15 wherein, after the point sum is determined, one or more of the wagering zones are highlighted to indicate which of the wagering zones have the wagering relationship matching the point sum, the point-sum zone matching the determined point sum is highlighted to identify the determined point sum.

20. A game of chance as in claim 15 wherein the wager tokens comprise a permanent denomination characteristic and a permanent and uniquely different token identification code for each wager token.
